(19) United States
(12) Patent Application Publication
(10) Pub. No.: US 2024/0249635 A1
(43) Pub. Date: Jul. 25, 2024

(54) FORMATIVE FEEDBACK SYSTEM AND METHOD

(71) Applicant: WESTERN UNIVERSITY OF HEALTH SCIENCES, Pomona, CA (US)

(72) Inventors: Alexander LEE, Pomona, CA (US); Brent FUNG, Pomona, CA (US); Marcel NGO, Pomona, CA (US); Sandra FARRAH-FRANCO, Pomona, CA (US); Steven FRIEDRICHSEN, Pomona, CA (US); Hubert CHAN, Pomona, CA (US)

(73) Assignee: WESTERN UNIVERSITY OF HEALTH SCIENCES, Pomona, CA (US)

(21) Appl. No.: 18/427,694

(22) Filed: Jan. 30, 2024

Related U.S. Application Data
(63) Continuation-in-part of application No. 16/333,007, filed on Mar. 13, 2019, now abandoned.
(60) Provisional application No. 62/395,714, filed on Sep. 16, 2016.

(51) Int. Cl. G09B 7/02

(52) U.S. Cl. CPC G09B 7/02

(57) ABSTRACT

iFormative Feedback (iFF) is an electronic formative feedback acquisition and analytics system which leverages mobile technology, QR codes, and web-based dashboards to provide users with meaningful, real-time, 360-degree assessments of performance. iFF is designed to record the spirit of a user's observations without increasing the administrative burden of data entry, security, collation, interpretation, and dissemination. Through iFF, organizations can efficiently track individual performance through downstream (supervisor to supervisee) and upstream (supervisee to supervisor) analyses of standardized observations recorded in the system.

### CROSS REFERENCE TO RELATED APPLICATIONS

This application claims the benefit of priority of U.S. application Ser. No. 16/333,007 filed on Mar. 13, 2019, which claimed the benefit of priority of PCT/US2017/052007 filed on Sep. 18, 2017, which claimed the benefit of U.S. Provisional Application No. 62/395,714 filed on Sep. 16, 2016. This application incorporates the entire contents of each of these applications.

### TECHNICAL FIELD

This technology relates to an electronic performance evaluation systems. More specifically, the technology relates to formative feedback acquisition and analytics systems for performance assessments.

### BACKGROUND

For many years, teaching methods have remained the same: an instructor imparts information to students through lecture or discussion and then tests the students on their understanding of that information. Studies show that these teaching methods tend to be passive and linear and do not assure student knowledge or comprehension. Effective learning requires integration of different methodology and assessment at multiple levels, including discussions, modeling, and practical exercises.

Feedback is an essential component in learning contexts and serves a variety of purposes including evaluation of student achievement, development of student competencies, and understanding and promotion of student motivation and confidence. Within teaching and learning activities, students perceive feedback as information communicated to the learner as a result of a learning-oriented action. Feedback strategies include both the content of feedback itself and the method used to communicate the feedback to students. Communication of feedback is important since the method selected may discourage or draw student's attention in the feedback process. In order to be effective, the manner in which feedback is communicated to the student must ensure student engagement with the content.

Formative assessment is specifically intended to generate feedback on performance to improve and accelerate learning. Knowing how students think in the process of learning makes it possible for instructors to help their students overcome conceptual difficulties and, in turn, improve their learning. Good feedback practice can help students clarify what good performance means, facilitate the development of reflection in learning, and deliver high quality information to students about their learning and competency. Feedback based on formative assessment is closely connected to instruction and provides information about how to improve performance. Feedback given as part of formative assessment helps learners to achieve their goals. Further, students can be instructed and trained in how to interpret feedback, how to make connections between the feedback and the characteristics of the work they produce, and how they can improve their work in the future.

In a clinical healthcare environment, patient safety and quality of care outcomes have garnered wide scope attention across all facets and disciplines. Dental educators face a huge societal burden due to the responsibility of determining how and when a dental student has achieved professional clinical competency, which includes the complex ability to perform independent, unsupervised dental practice.

The American Dental Education Association (ADEA) defines competency by the following behaviors: (a) synthesis of knowledge; (b) experience; (c) critical thinking and problem solving skills; (d) professionalism; (e) ethical values; and (f) technical and procedural skills. As a result of ADEA's advisory and educational policy role in dental education, there is a push for competency based-education (CBE) of dental students, which poses a challenge regarding the best practices approach for specific and accurate assessment methods.

Non-graded formative feedback is critical to establishing competence in any dental education program that strives for true CBE: most recorded daily grades in dental education clinical programs are a point of contention as they have a tendency to be either very subjective or centered down the middle of the grading scale, which is most likely inaccurate and non-specific. The advantage of a longitudinal formative feedback evaluation system is that it can deliver a “big picture appraisal of a student's overall competence” rather than competence at snapshots in time.

Today's educational classrooms rely upon technology to expand the boundaries of the classroom so that students can learn anytime, anywhere. The Internet provides an inexpensive and fast service for the delivery of content, peer collaboration, and accessibility to new teaching methods. To use technology effectively for learning, the learning process must be dynamic, active, and interactive.

Instructors should identify desired results, determine acceptable evidence of performance, and plan learning experiences and instruction. Courses and courses of study can be developed based upon desired results, goals, or standards and then the course can be built from evidence of learning called for by established educational standards.

Past efforts to provide an electronic assessment and reporting system that provides usable formative feedback have fallen short. Previous systems focused exclusively on the educational content of the learning exercises or the manner of providing feedback without successfully integrating the two. These previous systems and methods were primarily interested in recording summative assessments (e.g., a learner received an “A” grade, got 75% on a test score, or scored a 3 on a task) which captured snapshots of competence and provided a learner little guidance to improve. Any formative feedback recorded usually came in the form of free text input by a teacher. Subsequently, these systems had difficulty in acquiring and analyzing meaningful feedback over time. They were inadequate in recording formative feedback, compiling the results into actionable observations, and analyzing and distributing the results.

Analysis of a learner's accumulated observations is difficult, time intensive, and prone to clerical error because the formative feedback is not standardized. More importantly, recording free text can be arduous (requiring a great deal of time) and/or not uniform (e.g., lexicon between teachers is different), decreasing the overall likelihood of the feedback ever getting recorded and used. Without specific areas to improve and a method to track identified areas, a learner cannot effectively advance toward competency.

In addition, storing any formative feedback information and/or summative assessments that include free text and non-standardized variables requires a dynamic amount of memory. That is, the more detailed the formative feedback information, the more memory is needed as well as processing to catalog, assign, and write to the memory. Each entry in the database may be different sizes since the corresponding amount of memory is based on the amount of information that is provided. This increases the amount of data transmitted within the system, increases the amount of memory needed, as well as slows down processing in both the transmitting and receiving devices by having to find, retrieve, and transmit the unique and non-uniform data set.

### SUMMARY

Performance competence cannot be fully measured using stand-alone, snapshot, summative assessments like multiple choice exams and one-time examinations. For example, in the healthcare environment, practitioner competence can be more effectively measured through a longitudinal means, with many evaluations from multiple sources focusing on qualitative metrics (e.g., constructive criticism to improve weakness and praise to note strengths) as opposed to quantitative metrics (e.g., receiving a C− or a 100%) over a long period of time. For example, observations of the same student may be performed over an extended period of time (e.g., during dental school and/or beyond). Observation of the same variable may be performed or observation of different variables may occur during the course of the longitudinal study.

An administrative user can be a user who has a high level of access that can change and manage aspects of the application like evaluation variables, user levels, dashboard configurations, etc. An evaluator user can be a user who evaluates a subject. This is typically an instructor. A subject user can be a user who is being evaluated. This is typically a student. Metatags can be custom metadata values associated with users in the iFF application “metatags”. Examples of a metatag within the context of iFF would be the class year(s) associated with each student, the supervisor of an evaluator user, and emails of all users. This isn't traditional metadata (i.e., data about data) but instead data that serves to identify then segregate data as all response data in iFF is consolidated into a single table.

To significantly reduce the amount of data being stored and transmitted throughout the system, a single table is used and the dashboard computer decodes the message including the single table when a request for data is received in the dashboard.

Formative feedback—defined as information communicated to the learner that is intended to modify thinking or behavior for the purpose of advancing the learner toward competency—is especially important to tracking a practitioner's competency. Even though educators acknowledge the importance of this information, this information is difficult to acquire and even harder to make sense of. Performing formative feedback sessions, compiling the results, and analyzing the results is time-consuming and resource intense.

The claimed invention addresses shortcomings in prior systems by standardizing formative feedback into keywords, correlating each keywords with a unique reduced data set (e.g., a few bytes of information), and storing the unique reduced data set in a database. This provides for streamlining the feedback recording process to seconds, and delivering real-time, analyzed results to teachers and learners. That is, the data corresponding to the keywords is encoded or compressed into fewer bits for storage while still allowing for expanded reconstruction that provides the exact information corresponding to the original data. This provides improvements to the technical field that result in significantly more by reducing storage space (including hardware, power, upkeep, etc. corresponding to this storage space), reduced transmission time for transmitting the encoded information to allow for real-time, analyzed results while improving overall efficiency in handling the digital information.

For example, an input can be provided to a computing device associated with an administrator corresponding to information associated with behaviors an evaluator is to observe. This information can be descriptive but have no connotation. For instance, “diction” maybe an identified area for observation. Each area can be assigned a positive and negative counterpart. Each area counterpart can then be assigned a unique ID by the application, e.g., “positive diction” can be designated “PD” and negative diction” can be designated with ND. When an evaluator enters their observations, the application collects the unique ID but also identifying information associated with the evaluator (e.g., a user name of the evaluator), identifying information associated with the subject being evaluated, time/date of entry, location observation occurred, and potentially any other data which administrative users associate with evaluator users.

Evaluator users do not type in the results of their observations and thus save time typing “student's diction needs improvement” and instead creates an efficiency where the evaluator can simply select “diction” and indicate that it is a weakness. Administrative users have feedback that is standardized and directly input into an application's database thereby saving time. The application reduces processing power as feedback is recorded with the unique ID and not a long text format. That is, instead of sending throughout the network and storing “student's diction needs improvement” in the database, all that is stored is “ND”.

The claimed invention provides systems and methods that go beyond previous efforts by providing feedback on a formative assessment that is timely, constructive, motivational, personal, management, and directly related to assessment criteria and learning outcomes. The invention acquires, compiles, analyzes, and reports formative feedback evaluations. One example implementation of the invention includes an iOS formative feedback application that provides capabilities beyond previous systems by interpreting and framing pertinent comments into keywords, thereby cutting the time it takes evaluators to input this data to seconds.

The invention applies advanced analytics to the collected evaluation data and displays the results in an intuitive, real-time, graphical dashboard to administrators.

In an exemplary embodiment, an identification of which particular variables for analytics are to be observed by a user of a computing device associated with an administrator. Analytics are streamlined through standardization and shortening of data. Data points are shortened and truncated into unique IDs (e.g., “student's diction needs improvement” is now “ND”). Counting and interpreting “ND” is much more efficient than understanding and analyzing free text. By analyzing shortened data, complex analytics can be achieved with minimal processing power. When data is requested to be displayed to a user, the application uses a key to expand the data to make it human readable.

In this case, inputs would be unique IDs of responses plus any other data that an administrative user chooses to attach to an evaluator and subject users (e.g., evaluator name, subject class year, demographic data, etc.). The processor can record all this data into a single table. Based on the input provided by the administrative user identifying which information is desired from the collected data, the processor generates sub-tables that are nested within the single table. The administrative user defines the variables (e.g., “How many students received negative marks for diction in this past year?” would have the following variables: unique students, number of times “ND” was selected (and occurs within the single table), and whom “ND” was associated with, and data range of the past year. An output would be calculated based on the defined variables (e.g., “14 of 15 students this past year showed a weakness in diction at least 1 time”).

The invention provides a comprehensive electronic formative feedback system that addresses the assessment loop, allowing administrators to efficiently track, assess, and, if necessary, intervene in matters related to competency.

The invention is true to the principles of competency tracking through time, and the systems and methods of the invention can be customized to different clinical, business, educational, manufacturing, service, and other environments. Performance improvement plans, peer-to-peer evaluations, SWOT analyses—these items and more benefit from the support of formative feedback integrated into their processes and managed with the systems and methods of the invention.

The invention delivers solutions and eliminates the resource-intense endeavor by providing a learner with just-in-time feedback and appropriate intervention given today's budgetary constraints, diminished resources, and faculty and supervisor numbers. The invention provides an efficient and effective system of recording all respective data points that translate into the “big picture” for each learner/student. The systems and methods provide more than just a snapshot evaluation and instead create individual longitudinal track records for both technical and formative metrics.

In one example implementation, the invention provides a longitudinal, FERPA (Family Educational Rights and Privacy Act) compliant, mobile-based health professional formative feedback system. Input from end-users is kept at a minimum (e.g., 5 button presses or less), and the feedback provided is robust.

The application uses minimal user input to provide extensive feedback in the following ways. Leveraging scanned QR codes to quickly select subject users. Many similar applications have evaluator users manually select or search for subject users. This alone removes multiple button clicks. It allows administrative users to standardize feedback and focus on items they would like evaluated. This reduces data volume at the cost of data resolution. By making evaluations simpler and standardized, over time enough data points will compensate for the loss of data resolution. It can be 5 button clicks for a single evaluation, but the application is intended to be used regularly throughout a period of years by multiple different evaluator users.

The interface is an agile and accommodates record keeping of teaching moments in all dental medicine learning environments—preclinical, clinical, and CBDE (Community Based Dental Education). The system provides real-time tracking of a student's performance through the curriculum, allowing faculty to observe student trends and assess the results of interventions. The invention enables user friendly, meaningful, on demand tracking of an individual's progression to attainment of competency without increasing administrative overhead.

The formative feedback server can be configured to track all evaluation data in a single table. An entry within the table can include information associated with an evaluator user name, subject user name (e.g., evaluatee), data and time of evaluation, an indication whether the evaluation was fully or partially completed, and unique IDs of all the areas or topics of evaluations. Because all the data is located in a single table, relating one evaluation to another evaluation is simple. This is different and creates significantly more than the conventional computers systems and evaluation applications that store data on multiple different tables which requires extensive memory, additional processing and power necessary to retrieve and combine information from the multiple tables as well as maintain and update the index causing additional overhead.

In an exemplary embodiment, data can be analyzed and plotted into graphs to provide graphical information. This allows for observing overall trends with respect to a single user or a subset of users within the database.

The invention advances the state of electronic learning environments and assessment systems by converting and framing pertinent comments into keywords which can have positive or negative connotations. The invention uses mobile technology and workflow optimization to reduce feedback acquisition time and provides on-demand analytics to acquired feedback and real-time display of the results on mobile devices.

Because data is truncated, all data can be easily stored in real time. In an embodiment, an administrative user can set an interval at which analytics are updated. For example, the interval can be set as infrequently as once a year to as often as one every fifteen minutes.

When triggered to update data, the application can receive the latest set of data, aggregate the data based on the administrator user's input, and decodes the truncated data (e.g., unique IDs) into human readable text. By saving this decoding step until the very last step, this lowers the amount of processing power necessary. That is, in comparison the processor can be handling 10,0000 counts of “ND” instead of 10,000 counts of “student's diction needs improvement”. This saves significant processing resources as well as power resources throughout the system.

One example implementation of the formative feedback and evaluation system of the invention includes a formative feedback server and a formative feedback database. The formative feedback server receives a user file from an administrator computer. The user file includes an evaluator account, an administrator user level, and an evaluator user level. The user account and/or user level can be received via an optical label, such as a QR code.

The formative feedback server receives a keyword file and/or a category file and/or a performance ratings file from the administrator computer. The formative feedback server also receives a survey framework for a formative feedback evaluation from the administrator computer. The survey framework includes formatted questions for an evaluator.

In an exemplary embodiment, multiple surveys can be generated by an administrative user. For example, administrative users can set metadata that will help re-direct users to specific surveys. For instance, the application can support the following: administrative user labels two groups of subject users “1^{st} Grade” and “2^{nd} Grade”, administrative user associates “1^{st} Grade” with a survey labeled “Recess” and “2^{nd} Grade” with a survey labeled “Library”, and when an evaluator scans a subject user's QR code, the application checks the metadata and directs the evaluator users accordingly. If a subject user that is in the “1^{st} Grade” is scanned, then the evaluator user is directed to the “Recess” survey and if a subject user that is in the “2_{nd} Grade” is scanned, then the evaluator user is directed to the “Library” survey.

The formative feedback database stores any of the user file, keyword file, category file, and performance ratings file. The formative feedback server appends the survey framework to include user bibliographic information, keywords, categories, and performance ratings from the respective user file, keyword file, category file, and performance ratings file and delivers the appended survey framework to an evaluator computer. The keyword file can include standardized keywords and/or key phrases. Additionally, the keyword file can be created to include a neutral connotation keyword data file spreadsheet generated by an evaluating organization and describing assessment aspects of a performance task.

In an exemplary embodiment, a computer can associate metadata with each data point which can be customized by an administrative user. The computer can also encode feedback variables into truncated unique IDs.

The survey framework can include formatted questions based upon the keywords organized by the evaluation categories and provides a plurality of performance ratings indicators. The survey framework can be stored in the formative feedback database as a survey application. The survey framework application can be a web based survey application that runs inside a browser. The web-based survey application can run on an evaluator computer inside a browser. The survey framework embeds account credentials for evaluators and evaluates into the survey framework. The evaluator's (client) computer can scan an optical label to populate the survey framework.

In an exemplary embodiment, the survey application does not store the surveys. Instead it uses web-based survey applications and redirects users to them within a custom browser that does not display the URL or allow typical web-browsing features to maintain evaluation security. Metadata is used to direct users to the appropriate surveys. Metadata can be defined by administrative users.

Administrative users can choose to embed any number of data fields to the users table. These fields will then be passed on to each and every evaluation. The evaluator and subject users never have to be aware of these fields. For example, the administrative users create any number of metadata values (a.k.a. tags) then associate them with users. These tags will then be appended into the single evaluation table.

In an exemplary embodiment, the administrative user can create the survey framework in a web-based survey application like SURVEY MONKEY, QUALTRICS, or MICROSOFT FORMS. Administrative users can create metatags that can be correlated with users. The metadata can then be sent to the survey when a QR code is scanned. Metatags can also affect which survey(s) the evaluator users are sent to. The survey framework is not stored on the application.

The formative feedback server can receive a scan of an optical label from an evaluator computer and respond by further embedding bibliographic information of an evaluatee and/or procedural information of a task to be demonstrated by the evaluatee into the survey framework and sending the updated survey framework to the evaluator computer.

The evaluator computer sends a completed survey framework to the formative feedback server and to a dashboard computer where it is stored and used for analytics. For example, the formative feedback dashboard computer receives entered feedback from an evaluator computer and stores the entered feedback as an evaluation file, and the formative feedback server simultaneously receives the entered feedback and stores the entered feedback as an evaluation file in the formative feedback database.

In an exemplary embodiment, users can be directed to the survey and the survey data can be directly pulled from the survey via an application program interface (API) to the feedback server in real time. The feedback server then sends information to the dashboard computer where the dashboard decodes the information to make the information human readable.

The formative feedback and evaluation system also provides many analytics capabilities. For example, the survey framework can be a mobile computer application framework that securely displays an un-indexed URL. In an exemplary embodiment, analytic capabilities can be defined by the administrative user. The system provides significantly more because the evaluation data is stored in a single table with all the administrator user defined metadata. This makes processing much more organized and simple thereby reduces processing time and power while also reducing the hardware, power, and processing within the memory of the server.

The un-indexed URL can transmit and receive embedded text fields within the URL to ensure integrity of evaluations while allowing cross-platform access and data communication from servers. For example, metadata can be passed to the survey via embedded text values in the URL. For instance if the URL is “www.webpage.com” this URL will only direct the user to the webpage. However, if the metadata is added as embedded text values to the URL the URL will be “www.webpage&myname=Alex” where this URL will tell the webpage that the user's name is “Alex” and to greet them as such.

The system can include a formative feedback dashboard computer that receives and consolidates evaluation data received from the mobile computer application framework. The evaluation database can be held in a single table so no consolidation is necessary in within the database. The dashboard computer can then carry out scripted data transformations which is dictated by the administrative user to extract the information from the single table.

The formative feedback dashboard computer can apply scripted processes to the received data to provide data update intervals, user access levels, data calculations, data filtering, and dynamic graphical displays. In an exemplary embodiment, an administrative user can create a script using any data processing technology like R, POWERQUERY, or TCL. The administrative user creates the script, but because all of the data for each survey is held in a single table, manipulation is streamlined and processing resources and power are significantly reduced.

### BRIEF DESCRIPTION OF THE DRAWINGS

FIG. 1 shows a formative feedback system architecture in accordance with the invention.

FIG. 2 shows additional details regarding a process of creating formative feedback keywords, definitions, categories, and use in accordance with the invention.

FIGS. 3A-3F show example procedure categories, keywords, procedure phrases (definitions) and uses from example evaluator input criteria for dental students.

FIG. 4 shows examples of keywords and key phrases culled from example evaluator input criteria for dental students to assess a student's competence for dental procedures.

FIG. 5 illustrates assessment categories identified by evaluators for use as a basis in determining keywords and key phrases in accordance with the invention.

FIGS. 6A-6F show a sample workflow of one implementation of the formative feedback system of the invention utilizing QR codes and customized keywords to efficiently acquire formative feedback.

FIG. 7 shows a pictorial representation of leveraging the QR codes of the formative feedback system of the invention to accelerate faculty authentication and student selection for provided feedback.

FIG. 8 shows a sample trend analysis dashboard providing a graphical analysis of the four categories of interest from FIG. 5.

FIG. 9 shows a sample trend analysis dashboard using the same dataset used in FIG. 8 but drilled down to an individual user.

FIG. 10 shows an example evaluation dashboard indicating strong and weak evaluation areas.

FIGS. 11A and 11B show an example evaluation dashboard indicating evaluator performance.

FIGS. 12-14 provide example dashboards showing evaluator performance at the individual evaluator level.

### DETAILED DESCRIPTION

The invention provides a framework for providing feedback regarding a formative assessment.

The invention creates a background structure that enables timely, constructive, motivational, and personal reactions directly related to assessment criteria and learning outcomes. The invention acquires and analyzes evaluation phrases and compiles keywords, clinical categories, and ratings, including ranges, positive and negative reviews, trends over time, free text comments, and other evaluation metrics. The invention receives evaluator notations indicative of the proficiency of a student/evaluatee/learner performing a task. The invention creates feedback reports from the formative feedback evaluations and provides a host of analytics to help both the evaluator and the student understand and assess the student's proficiency and competence for the tasks/skills they perform.

### System Architecture and Process Overview

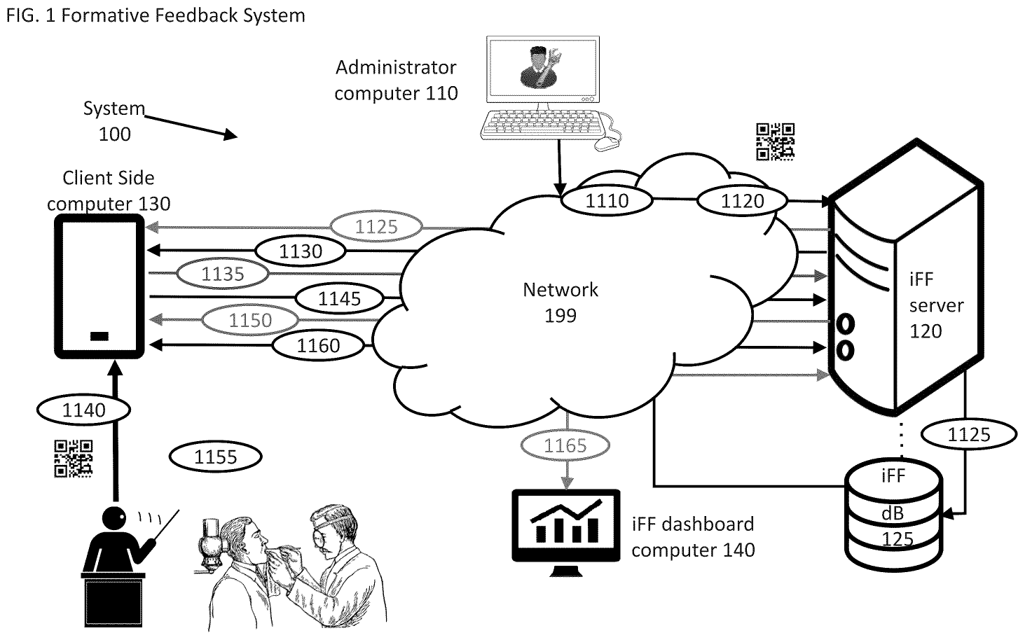

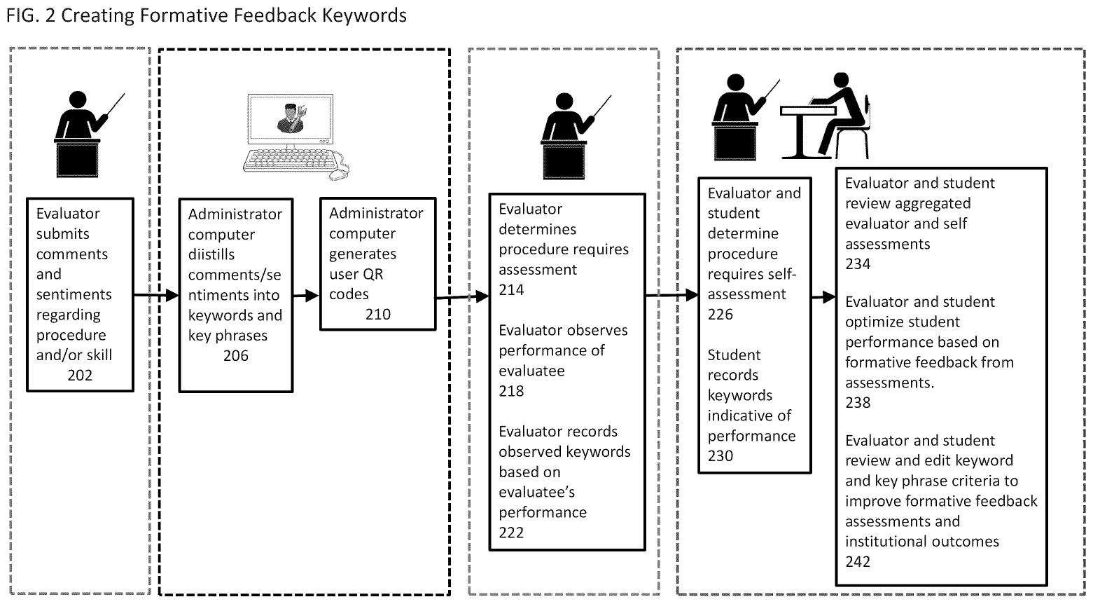

As shown in FIG. 1, one example of the invention includes formative feedback system 100 that includes distribution components, applications, and services that carry out the formative feedback processes of the invention described in the FIGS. 2-14. FIG. 1 illustrates the hardware and technical components used to instantiate the sources, apps, and distribution endpoints shown in FIGS. 2-14.

The system 100 includes administrator computer 110, iFF server 120, client side computer 130, and iFF dashboard display device 140. The system components communicate through network 199, such as the Internet or other computer communication networks, for example.

As shown in FIG. 1, in block 1110, the administrator computer 110 creates user levels, user accounts, and QR codes, which are stored in iFF Server 120. The invention utilizes 3 user levels/user roles: administrator, supervisor, and supervisee.

An administrator is an individual who manages the formative feedback system within an organization. Tasks an administrator performs include: create and manage user accounts, generate supervisee identifiers (e.g., optical labels such as QR codes), establish areas which require assessment, create category descriptive keywords, manage web-survey processes, and monitor institutional performance.

In an exemplary embodiment, one or more of the devices in system 100 can be configured to append metadata, consolidate evaluation data into a single table, execute analytics scripts, and decode data to make it human readable. Different devices can do different functions. For example, the administrator computer 110 can be used to append metadata. The iFF server 120 can store the single table. The iFF dashboard display device 140 can be configured to execute analytics scripts after receiving a request for evaluation data and receiving the single table from the iFF server and then decode the relevant data from the single table based on the request for evaluation data.

A supervisor is an individual who records, monitors, and affects supervisee performance. Tasks a supervisor performs include: record supervisee feedback with a mobile application in accordance with the invention and utilize the system dashboard to monitor and improve self and supervisee performance. A supervisee is an individual who records, monitors, and affects self-performance. Tasks a supervisee performs include: record self-assessment with the mobile application of the invention and utilize the system dashboard to monitor and improve self and supervisor performance. These user levels can overlap (e.g., a supervisor can also be a supervisee, an administrator can also be a supervisor and supervisee, etc.). In an exemplary embodiment, different calculations can be performed based on the role of the user interacting with the device. For example, the dashboard can be scripted to ignore all negative feedback if a specific metatag is included in the single table received from the iFF server.

QR codes are unique identifiers of each formative feedback system user with each identifier being stored in the iFF Server and iFF database. That is, similar information can be received from multiple evaluators and stored in the single table. Attached to this unique identifier is user information such as name, job title, email, and other individual bibliographic information. The type of information associated with each identifier is expandable for each use case.

The administrator computer 110 receives input from different evaluators and takes the input to establish areas (e.g., practice areas, names of procedures, timing of procedures, and other considerations related to establishing the core and ancillary competencies of the evaluatees/students/learners).

iFF Server 120 provides functionality for other programs and devices, including client side mobile computer 130. iFF server 120 provides services to client side computer 130 and to administrator computer 110 and iFF dashboard display computer device 140. iFF server 120 shares data and resources among multiple clients and performs computations for the clients. iFF server 120 includes iFF database 125. For example, in one implementation of the invention, the iFF server 120 is a SQL database server.

While FIG. 1 shows a single iFF server 120, two or more servers or computing devices can be substituted for any one of the devices in the system 100. Accordingly, principles and advantages of distributed processing, such as redundancy, replication, parallel processing, and other communicated and coordinated actions can be implemented as desired to increase the robustness and performance of the devices and systems of the system 100.

The system 100 can also be implemented on a computer system or systems that extend across any network environment using any suitable interface mechanisms and communications technologies including, for example telecommunications in any suitable form (e.g., voice, modem, and the like), Public Switched Telephone Network (PSTNs), Packet Data Networks (PDNs), the Internet, intranets, and combinations of the above.

For clarity and brevity, FIG. 1 shows a single iFF server 120 connected to a single client side computer 130 via communication network 199, but it should be understood that any number of client side computing devices can be employed in the exemplary system 100.

Additionally, in block 1120, the administrator computer 110 creates standardized keywords, evaluation categories, and/or ratings (e.g., numerical ranges, indicated levels of proficiency, positive/negative, pass/fail, and other types of performance ratings.) of interest for organization. The manner in which the administrator computer 110 creates standardized keywords is detailed below with regard to FIGS. 2-14.

Once the administrator computer 110 creates the standardized keywords, evaluation categories, and ratings, the administrator computer 110 transfers the keywords, categories and ratings to the iFF server 120. The iFF server 120 stores the keywords as a keyword data file in the keyword database. The administrator computer 110 inputs these keywords directly into the web-based survey application, which is exported to the iFF database 125 and dashboard computer 140 via a CSV (comma separated values) file, as one example. In an exemplary embodiment, keywords can be defined and stored in the survey (a.k.a. keyword database). The survey response data can be exported via API to the iFF database. The dashboard computer can query the iFF database to perform analytics as there is no specific dashboard database. That is the dashboard does not have access to a memory or storage media. All information that is analyzed and displayed through the dashboard is received from the iFF server thereby reducing the amount of hardware, processing requirements, and power necessary for powering and interacting with non-transitory media in the dashboard.

In one example implementation of the invention, the keywords are exported from the web-based survey application through an API, through a manual export, or as a text entry process facilitated by an administrator. Similarly, the iFF server 120 stores the created categories as a category data file in the categories database, and the ratings as a ratings file in a ratings database. The respective keyword database, categories database, and ratings database can be partitioned from a single storage medium or can be located alongside each other in one physical computer system or can be geographically separated in different computers, different buildings, different cities, and different countries. For simplicity, in the example system 100 shown in FIG. 1, the respective databases are housed in iFF database 125.

In addition to the ratings files, category files, and keyword files, the Administrator computer 110 generates a survey framework for the evaluation based on the ratings files, category files, and keyword files. For example, in one implementation of the invention, the survey framework includes formatted questions based on the keywords organized by the created categories where an evaluator will select a rating to characterize a student's proficiency at a particular task. The administrator computer 110 sends the survey framework to the iFF server 120, where it is stored in iFF database 125 as a survey application at a URL.

In an exemplary embodiment, the survey framework can be originally a survey application with its own URL before heading to the iFF server. The iFF server can receive user information (e.g., from QR code information), check metadata that relates to the correct survey, and then transmit data and user information to the correct survey URL.

The survey application can be a web-based survey application, for example, that embeds additional data from files stored in iFF database 125 or elsewhere as the individual evaluations are compiled. In one example implementation, the web-based survey application is an HTML5 form application (e.g., similar to Google Forms, Survey Monkey, and other forms) which can be customized by an administrator. The web-based survey application is displayed within the iFF mobile application through an embedded web viewer. User credentials are input into the iFF mobile application through scanning a valid QR code, for example. The QR codes can be displayed on a static medium such as a badge or template or the QR code can be displayed on a display of a device that has the iFF user application installed on it.

These credentials are checked against the information housed in the iFF server 120 and a subsequent URL is generated with the user credentials embedded within the URL itself. This URL is hidden from the users as a security feature. In an exemplary embodiment, user credentials can be embedded within the URL when the iFF server communicates with the survey framework. When an evaluator user is logged in and scans a QR code, the iFF mobile application can connect with the iFF server and an appropriate subject user can be selected. Once the subject user is selected, all metadata from the evaluator user and the subject user are piped to the survey framework. This URL with embedded metadata can open in the iFF mobile application browser which does not display the URL to the user. This prevents any user from reverse engineering the URL to manipulate metatags. That is, it provides a security measure to maintain integrity and prevent any outside tampering with the single table stored at the iFF server.

In addition to one example implementation of the invention using a web-based survey app running inside a browser, the application can also be client-based, where part of the program is downloaded to the client side computer 130, but processing is done over the network 199 on the iFF server 120. For example, because feedback options can be controlled by the administrator user, the iFF server can shorten feedback text into minimal characters then the dashboard on the client side computer 130 can decode the information to display human readable information. Because only the shortened feedback text (and not human readable information) is stored in the single table, processing is reduced by eliminating text parsing as well as overhead. This also provides substantially more by removing a step necessary to provide cleaning data to do analytics at the dashboard.

The system 100 creates individual evaluations using the survey application as a framework. The survey application imports a range of questions (e.g., Likert scale, multiple choice, true/false, fill-in-the-blank, and other types of question ranges) generates an unindexed URL, and embeds text into the form. The survey application generates an unindexed URL for security purposes. For example, the computer generates a URL by concatenating information from meta tags. The appropriate metatags are pulled by taking the logged in user and combining it with the subject user whose QR code was scanned. Because the invention utilizes embedded text fields within the URL itself to pass information from the iFF server 120 to the survey application, publicizing this URL could compromise the integrity of the assessments being used in a particular deployment and could, potentially, allow any user to enter unregulated data into the iFF system 100.

While the URL is un-indexed for maximum security, it also needs to be accessible to any user with the address, ensuring maximum compatibility within the wide range of mobile products on the market today. For example, in one implementation of the invention, the iFF system 100 utilizes a Qualtrics survey platform. For example, the URL with embedded metadata needs to remain secret from both the evaluator and the subject users. By displaying a webpage in a custom web browser that does not have a URL bar, the evaluator users can interact with the survey framework without a chance for re-engineering of the framework. That is, it prevents the evaluator or the subject users from accessing the data in the single table stored in the iFF. This secures the survey framework from all users except the administrator users. Other web-based survey applications that allow users to easily create and manage survey forms with differing question types (e.g., Likert scales, multiple choice, heat map based questions, etc.) can also be used. Web-based survey applications that can publish un-indexed URLs which support embedded text fields, have an API which can export data directly to the iFF Servers 120, and are user-friendly yet robust in their scalability and ability to adapt to different organizations and different methods of evaluation. For example, the iFF application, via API capabilities within various survey frameworks, does so programmatically. When an event is triggered or time is set, the iFF server retrieves data from the survey.

In block 1125, iFF Server 120 embeds account credentials for the evaluators and the evaluatees/students/learners into the survey application and stored at a secure URL. For example, administrative users create metatags which are queried when a QR code is scanned from the iFF server, then the iFF server concatenates a URL with the embedded metatags into the survey. Once the system 100 makes the account credentials part of the survey application, the system 100 provides the secure

URL to the client-side computer 130 in block 1130.

The system 100 takes advantage of the portability and mobility of the client side computer 130 to move about and change locations depending upon the location of the evaluation. In some example implementations of the invention, client side computer 130 is a mobile device, such as a tablet, smart phone, or other mobile computing device. When client-side computer 130 is a mobile device, the URL is displayed securely in a client side mobile app. The client side mobile app is a computer program that performs a group of coordinated functions, tasks, or activities for the user. The client side mobile app is an application optimized for mobile devices that provides the ability to check evaluator and learner credentials with the iFF server 120, scan QR codes, and display URLs without revealing the physical address to the user. In an exemplary embodiment, the URL is displayed in a custom browser embedded within the iFF mobile application. The QR code is located either physically on the subject user (e.g., on a badge or other tangible medium) or on the subject user's mobile device that has iFF installed. Evaluator users also have access to a subject user search function where users can be searched for by name.

To begin an evaluation or to otherwise record an encounter where an evaluator observes and documents performance of an evaluatee demonstrating a particular behavior or skill, the evaluator logs in to the client side application and accesses the survey application from iFF server 120 via network 199 as noted in block 1135. The login credentials of the evaluator provide access to one or more survey applications from the iFF server 120. For example, evaluator users can login to the iFF mobile app with their username and password. When the iFF mobile app connects with the iFF server (such as when a QR code of a subject user is scanned), then metatags of the evaluator users are queried and passed onto the survey.

The evaluator can select an appropriate survey application and then enter evaluatee information into the survey application. In an exemplary embodiment, the administrative user can identify and set which surveys are appropriate for which evaluators and subject users. In one example implementation of the invention, the evaluator enters the evaluatee information by scanning a QR code of the evaluatee as shown in block 1140. The QR code provides bibliographic information regarding the evaluatee as well as additional information such as the task to be performed, the location of the procedure, and other information relevant to the task to be demonstrated. In an exemplary embodiment, the QR code can be generated by an administrator user. QR codes communicate with the application server when scanned, which then recognizes which metatags to append based on the QR code. This metadata is then passed to a survey.

For example, in one example implementation of the invention to evaluate dental students and provide formative feedback regarding dental procedures the students perform, the QR code provides patient information, dental equipment information, and other data relevant to a dental procedure to be performed. In an exemplary embodiment the QR codes are generated by administrative users and the administrative users can use a unique identifier like a subject user's student ID number, an evaluator user's employee, or a dental license number to create the QR code.

Once the evaluator scans the QR code, the code is sent to the iFF server in block 1145, and in block 1150 the application survey receives (from iFF server 120) the files stored by the administrator computer 110 on iFF server 120 (and iFF database 125) that include the bibliographic, procedure, location, and other data related to the behavior or skill that the evaluatee will demonstrate and that the evaluator will evaluate. In an exemplary embodiment, the QR code can be printed and given to a subject user or it can be displayed on a subject user's mobile device if they have and are logged into the iFF mobile appl. Metadata can be passed from the iFF server to the survey via a URL that is concatenated by the iFF server based on the information extracted from the QR code by an evaluator user's mobile app.

The scanned QR code, created by the administrator for each user with all the embedded information necessary to identify and categorizer the individual prepopulates fields in the application survey based and its validity is checked against the credentials stored on iFF server 120.

As the evaluatee performs the behavior or skill (e.g., dental procedure), in block 1155 the evaluator observes the procedure, scans the evaluatee's QR code which opens the iFF mobile application's secure web browser prepopulated with embedded user credentials from the QR code (which is also validated against the iFF database). The embedded data is communicated to the mobile application through the URL. Based on the generated URL with user credentials, the web-based survey application displays the keywords, categories, and ratings (e.g., ranges, pos/neg, etc.) stored in the iFF server 120 and iFF database 125 that were used to populate the survey application above. In one example implementation of the invention, the entered data is stored within the web-based application itself, the iFF database 125, or as a CSV file on an administrator's computer 110. In one example of the dental use case, this information is stored within the web-based application and then automatically synchronized with the iFF database 125. For example, data can be synchronized by an API command. The trigger can occur by event (e.g., when a response survey is submitted) or by time (e.g., once every 15 minutes).

As the evaluator enters feedback into the survey application, in block 1160 the feedback is sent in real-time to the iFF server 120 where it is stored in iFF database 125. The feedback is simultaneously sent to iFF dashboard computer 140 in real-time in block 1165. iFF dashboard computer 140 collates, analyzes, and distributes the feedback data to other users. The iFF dashboard computer can collate, analyze, and distribute feedback data to other users based on scripting defined by the administrative user. In some embodiments, R, POWERQUERY, and TCL can be used as data analytics languages to create the scripts.

For example, in a case of a dental student performing a dental procedure, the feedback from the evaluator is sent to iFF server 120 as well as to peer review groups, other dental evaluators, and the evaluatee. In an exemplary embodiment, the recipients of the feedback can be identified by their metatags for each response. The iFF dashboard computer 140 provides a graphical, web-based application that automatically acquires data from the survey application and stores the survey (feedback) data and ratings. The acquisition and storage processes can be scheduled to periodically move stored data from one point in the workflow to another (i.e., from one device or computer to another). For example, data stored within the framework of the web-based survey application needs to be moved to the iFF dashboard computer 140 for analysis. The frequency with which the data transfer of the survey data happens can be customized for every use case. In one example implementation of the invention, the formative feedback system 100 leverages the survey framework API to export data in a CSV (comma separated values) format to the iFF dashboard computer 140. The iFF dashboard computer 140 stores the received export data and configures the export data as dashboards using visualizations to tell the story of the survey data, and therefore the evaluation. For example, by leveraging metatags and holding all responses into a single table, data can be easily transported and analyzed to tell the story. The dashboards provide a user interface to organize and display formative feedback. For example, in one implementation of the invention, the iFF dashboard computer 140 modifies basic Microsoft Power BI dashboard files to organize and display the formative feedback. The Microsoft Power BI dashboard takes data from multiple sources (e.g., SQL databases, Oracle databases, CSVs, XLS, JSON, and other data sources), applies programmed queries to the consolidated data, and displays the information as an HTML5 web-page. The file format used by the invention modifies the Microsoft Power BI PBIX format. In one example implementation of the invention, data is scheduled to be exported and updated once a day. In other implementations, the data is scheduled to be exported and updated after every evaluation is completed.

The iFF dashboard computer 140 also stores the feedback data while applying security to the stored data. The iFF dashboard computer collates the data in a number of different predetermined fashions (outlined further below) and displays the resulting feedback information according to row-level credentials to appropriate users. User accounts and security levels are established by administrator computer 110 when establishing the user accounts (e.g., evaluator and evaluatee accounts, peer review accounts, and other party accounts) as described above. The system 100 provides formative feedback to the interested parties in a customizable intuitive fashion as outlined below with regard to the iFF dashboard and metrics section.

### Formative Feedback Keywords

As outlined above, the administrator computer 110 receives input from evaluators regarding the content and characteristics of the procedure/skill that an evaluatee will perform. In an exemplary embodiment, the evaluator user can log into the iFF mobile app and then scan a QR code. In response to extracting information from the QR code, the iFF mobile app can communicate with the iFF server, query metatags about the evaluator and subject users, concatenate a URL, then display this URL to the evaluator user with pre-filled fields within the survey. An evaluator can enter an evaluation, which is recorded in the survey. Upon a pre-established interval or event, survey response data can be uploaded into the iFF server. Dashboards can query iFF server for data and perform data manipulation based on a script established by the administrator user. Dashboards can then display information to individual users based on their individual access levels (e.g., subject users will only see their own data while evaluator and administrator users will see more or all subject users).

Formative feedback is difficult and time consuming to record and analyze due to the variable nature of comments. Different evaluators often utilize synonymous terms to describe the same sentiment. Breaking down these comments to make them useful takes many hours and interpretation.

Consequently, displaying this information in real-time is nearly impossible.

As further shown in FIG. 2, the invention overcomes these obstacles by distilling the most common issues in a discipline into keywords. As outlined above, the administrator computer 110 receives the comments and sentiments from evaluators in block 202 and distills the common issues and tasks in a task/discipline into keywords and key phrases in block 206, utilizing generalized words that are neutral, then allowing a user to apply a positive or negative connotation/rating as the feedback for the evaluatee. This user-interface allows for a varied, robust, yet standardized responses that encapsulate the pertinent details of any process.

The assessment comments and assessment phrases and skill descriptions provided by evaluators often relate to specific steps performed when carrying out a task (e.g., a particular dental procedure) or relate to the environment in which the task is performed (e.g., individual categories of patients) or to overarching organizational goals (e.g., a focus of a particular practice is on exceptional bedside manner). The administrator computer 110 receives the comments, phrases, and descriptions and is tasked with parsing the feedback into keywords, which hold importance to an organization. In an exemplary embodiment, the device records all data and importance/priority is not determined. Feedback can be encoded into a unique ID then decoded to display to make it human readable. Because the demands of each area of expertise and expectations of each organization/task are different, the exact metrics and parsing strategies are customized and determined on a use case by use case basis. The iFF system 100 is optimized to record standardized formative feedback, but there are no barriers to it recording other kinds of feedback (e.g. summative feedback), metrics (e.g. number of procedures done), or media (e.g. photos, soundbites, etc.).

In one example implementation of the invention, the administrator computer 110 receives comments, phrases, and descriptions and parses those data files using previously acquired academic data and established standards from CODA, the Commission on Dental Accreditation, which is a national organization that grants accreditation to educational institutions that wish to give degrees within the dental field. CODA provides each accredited dental institution with clear standards regarding evaluation tasks that must be reviewed, evaluated, and tracked for accreditation to be maintained. These standards were evaluated by multiple administrators, surveys were given to academicians within the institution to gauge what qualities were critical components in dental education, and consolidated into 4 meaningful categories: Preparation, Process, Procedure, and Professionalism. Preparation is a user's ability to ready themselves for a given dental encounter. Process is a user's adherence to established procedure and protocols. Procedure is the technical performance on a dental procedure. Professionalism is a user's conduct in relation to the individuals within the given dental encounter. The administrators then parsed evaluation comments and criteria to create (for example, 8 to 20) neutral keywords which described qualities within these categories. For example, some keywords within the Preparation category are: Armamentarium, Detail Oriented, Evidence-Based, Infection Control, Informed Consent, and Knowledgeable. Displayed strengths or weaknesses within these keywords indicate competency or lack thereof in Preparation.

In block 210, the administrator computer 110 generates user QR codes as outlined above. In block 214, the evaluator determines that a procedure requires assessment, and in block 218, the evaluator observes the performance of an evaluate performing the procedure/task. The evaluator records observed keywords based on evaluatee's performance in block 222.

In block 226, the evaluator and the student determine that the procedure requires self-assessment by the student, and the student records keywords indicative of her performance in block 230. In block 234, the evaluator and the student review aggregated evaluator and self assessments and optimize student performance based on formative feedback from the assessments in block 238. For example, a faculty member (i.e., evaluator) indicates that a student's “Use of Resources” was not optimal while the student followed “Infection Control” protocols well. The evaluator and the student can then optimize the student's performance by discussing and reviewing improvement opportunities for those skills in the procedure that were not optimal and can review the student's high-levels of achievement and competence in those skills in the procedure on which the student performed well. This efficient, standardized, and granular acquisition of comments allows a user to capture the essence of an encounter without not impeding their productivity.

Additionally, in block 242, the evaluator and the evaluate review and edit keywords and key phrases used in the formative feedback survey to improve the assessments and to provide more meaningful evaluation of skills and procedures. Additional key words and key phrases, as well as edits to existing key words and key phrases are provided to the administrator computer for use on subsequent formative feedback assessments. Reviewing and revising the assessment criteria helps improve overall institutional outcomes.

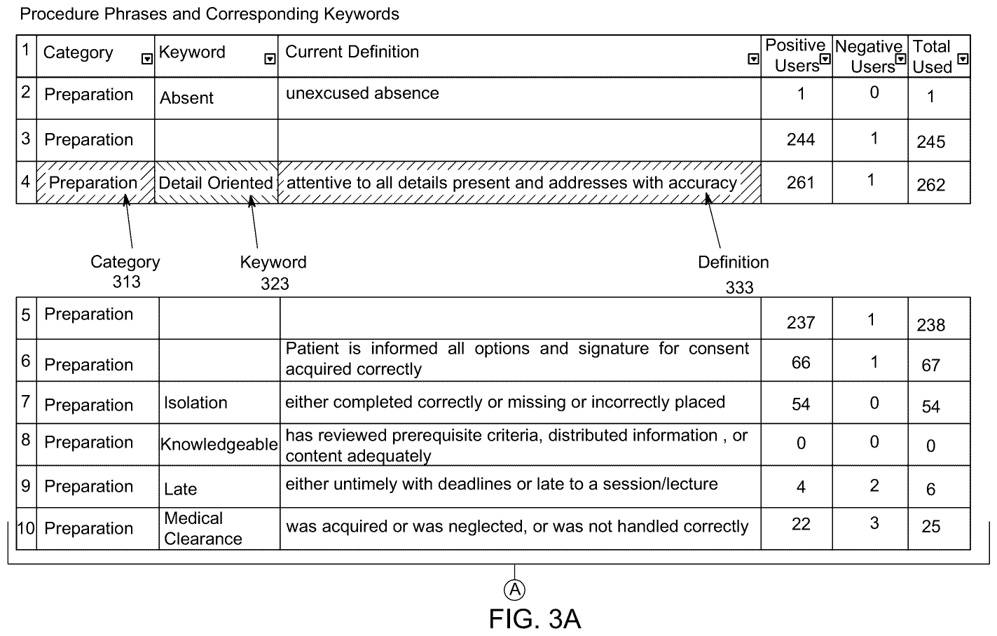

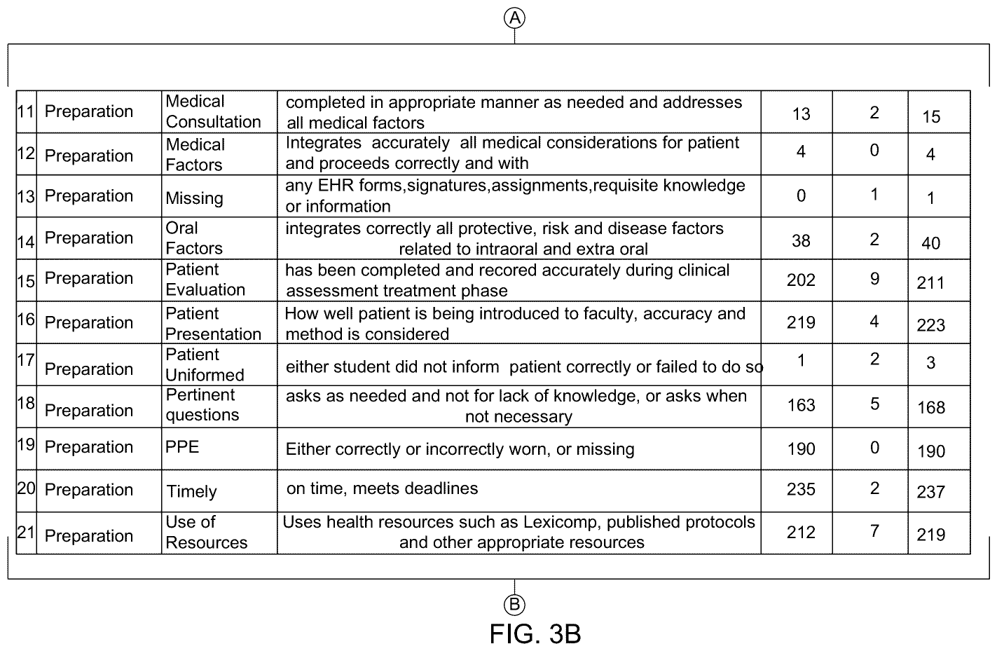

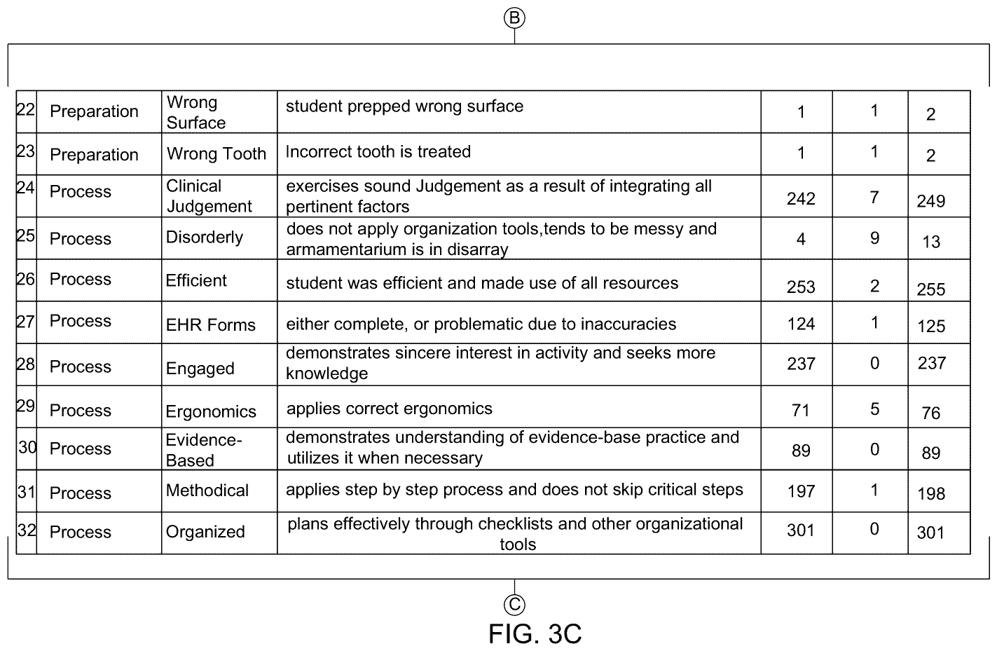

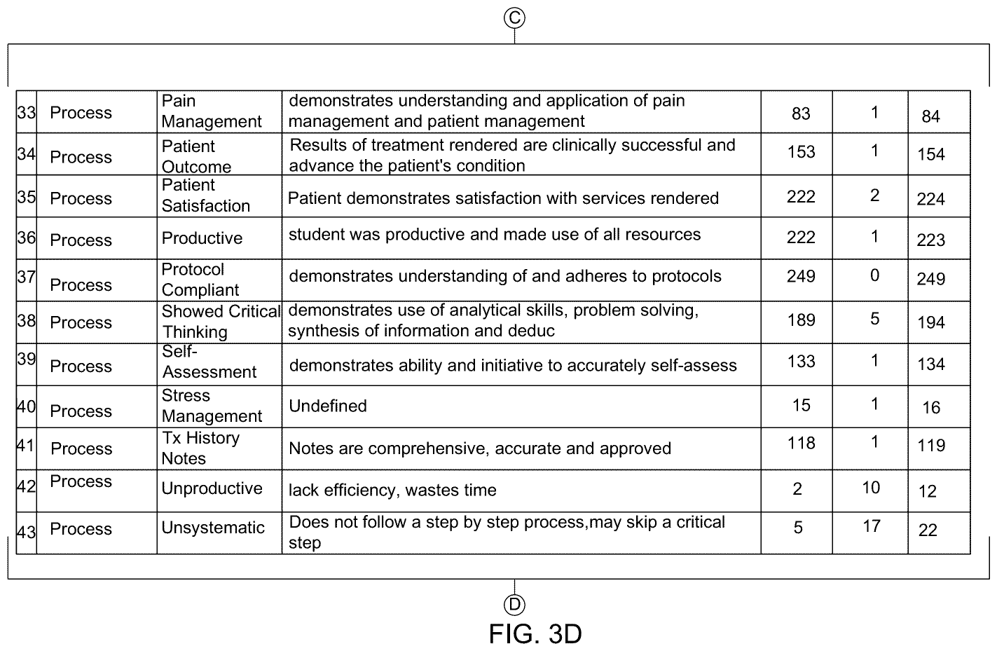

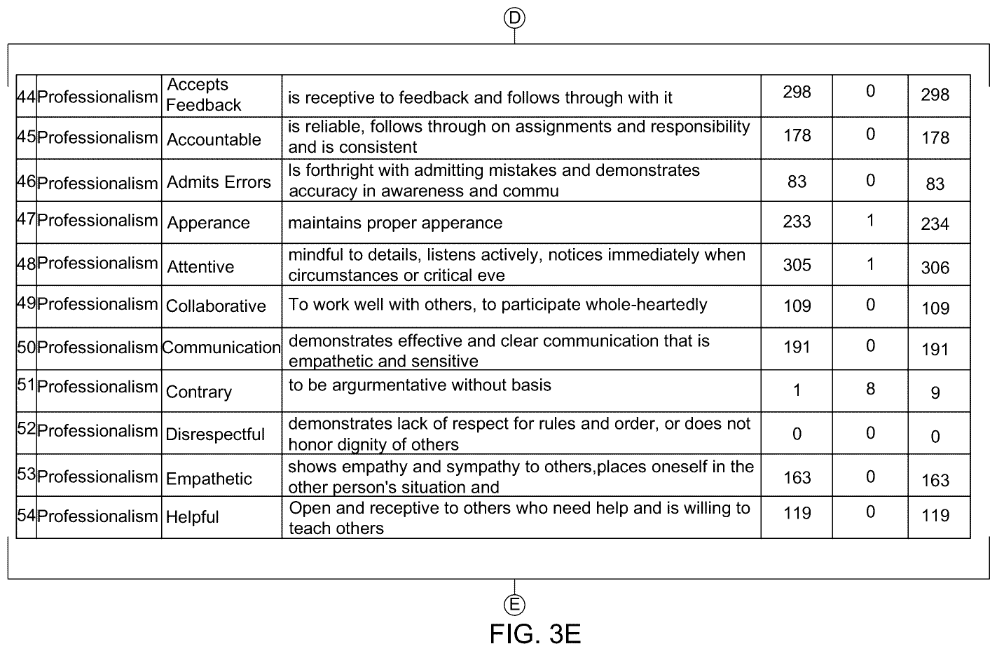

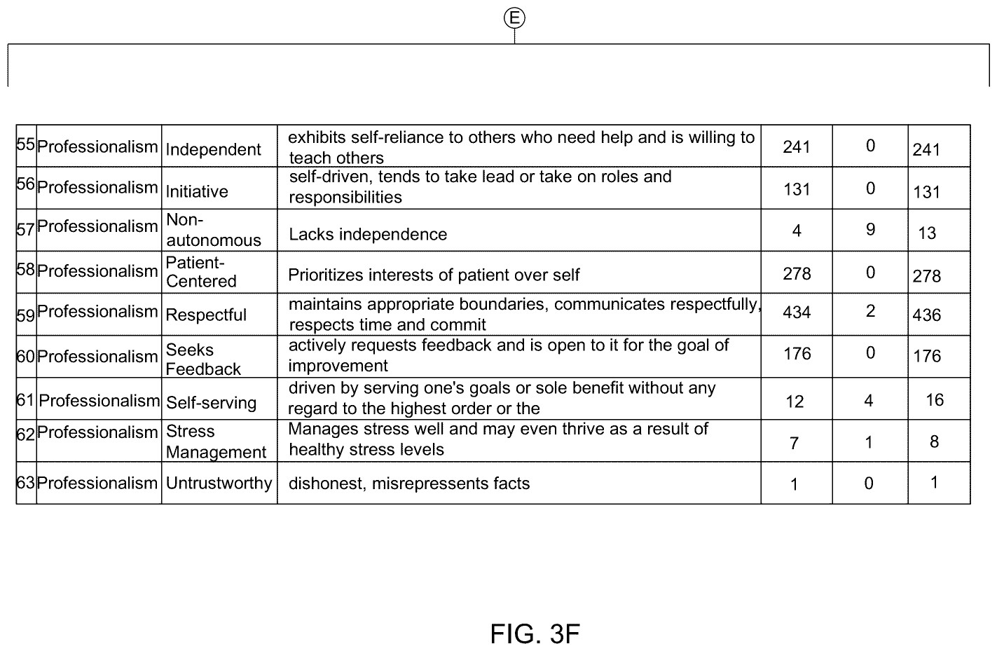

FIG. 3 shows a table of procedure phrases and corresponding keywords received from evaluators. The administrator computer 110 culls the received phrases into keywords and categorizes the keywords based on additional evaluator input.

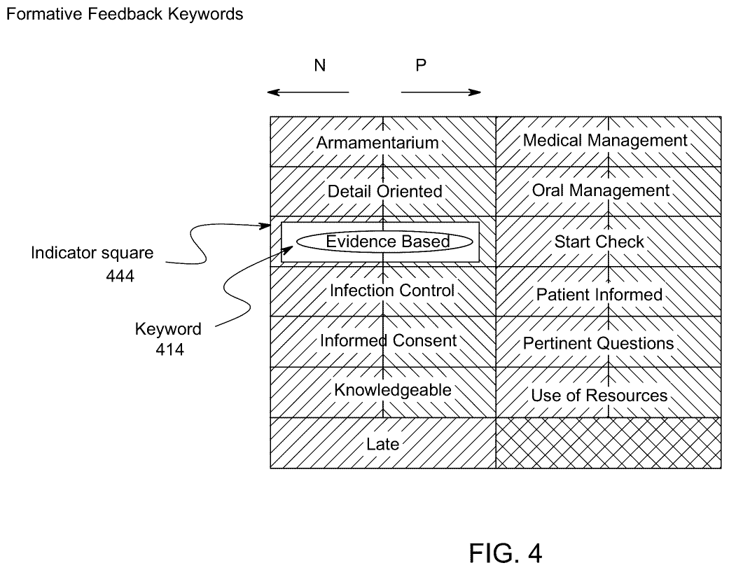

FIG. 4 shows examples of keywords and key phrases culled from example evaluator input criteria for dental students to assess a student's competence for dental procedures. The administrator computer 110 receives evaluator input criteria. One example shown in FIGS. 3 and 4 is evaluator input (definition) related to details. The evaluator input 333 characterizes this performance criterion as “attentive to all details present and addresses with accuracy.” The evaluator indicated that this performance criterion relates to an evaluatee's preparation, as shown in the category block 313. The administrator computer receives the evaluator criteria 333 and processes the text and context, ultimately deriving a key word or key phrase. In this example, the administrator computer derived the key phrase “detail oriented” 323.

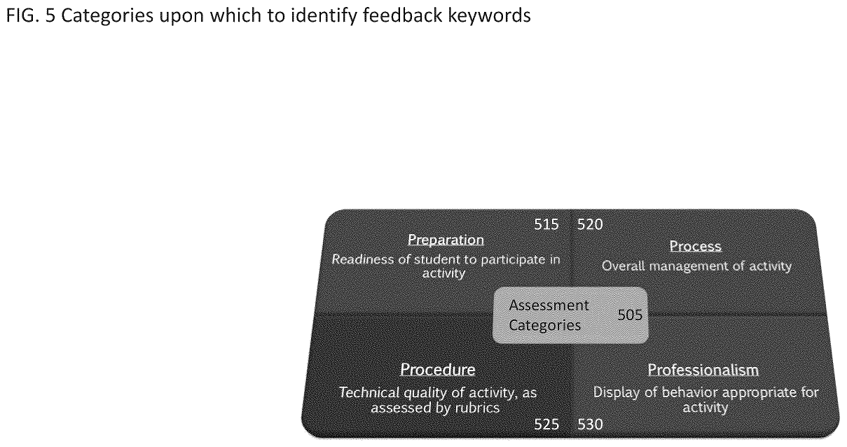

As outlined above, because the demands of each to-be-evaluated area of expertise and the expectations of each organization and task are different, the exact metrics are determined on a use case by use case basis. Typically, the administrator (computer) assesses all the feedback which are currently available from evaluators, identifies the evaluation criteria selected by their organization, task, evaluators, etc. as important, and then generates neutral descriptive terms (i.e., keywords and/or key phrases) which describe these areas using parsing rules and truncation based upon evaluation guidelines provided by the organization, evaluator(s), and credentialing bodies. Often, the system 100 uses truncation and parsing rules generated directly by evaluators. For example, in the example implementation shown in FIGS. 3 and 4, these keywords were generated based on recommendations by dental academicians who are familiar with clinical procedures, academic accreditation standards, and vision of colleges of dental medicine. In an exemplary embodiment, keywords can be identified by the administrative user. As shown in FIG. 5, the evaluators identified four categories 505 that were deemed pertinent to dentistry: preparation 515, process 520, procedure 525, and professionalism 530. The keywords were then generated by administrator computer 110, defined, and evaluated by numerous faculty focus groups (i.e., evaluators) until an organizational consensus was reached.

FIG. 4 shows several key phrases as they appear to the evaluator. For example, the “detail oriented” key phrase 414 shows a neutral indication, where half the indicator square 444 is red (more negative) and half the indicator square 444 is blue (more positive). The evaluator can slide the indicator square toward more positive (along direction arrow P) to provide a positive rating of the evaluatee's performance of this criterion or can slide the indicator square toward more negative (along direction arrow N) to provide a negative rating of the evaluatee's performance of this criterion. In either case, the more the indicator slides toward either fully positive or fully negative, the more strongly the performance was indicated.

The examples of key words and key phrases shown in FIGS. 3 and 4 are used with dental students in preparation for dental procedures. The administrator computer generalizes original evaluator input criteria and terms and determines key words as key phrases. Each of the generalized key words and/or key phrases is used as a rating criterion, and the evaluator scores the evaluatee against the various rating criteria. The evaluator can provide a positive, negative, or neutral indication of the evaluatee's demonstration of the key word/key phrase and can provide graduated indications within the positive, negative, or neutral indications. Evaluators can quickly record their impressions of an aspect of a procedure in a standardized format.

### Optimization of Assessment Workflow

The formative feedback system of the invention minimizes error and effort in the feedback acquisition process. The system utilizes QR codes or other optical labels, including matrix bar codes that include data and information regarding the object to which they are attached. The formative feedback system of the invention save both evaluators and evaluatees time, relieving users of the need to manually enter bibliographic information of the evaluatee and the skill or task that the evaluatee is about to perform. That is, the formative feedback application can accurately sort data based on the passed metatags and then efficiently transform data by shortening verbose data into unique IDs. This time savings provides an important benefit in large organizations where many individuals (e.g., evaluatees/learners/students) are evaluated at any time. With the formative feedback system of the invention, evaluators tap, scan, and evaluate. For example, evaluators can utilize the iFF mobile application and tap on the touch screen of the device running the iFF mobile application. Users can tap on the app to trigger functionality, one of which is scanning QR codes with the attached camera. With the time saved on each individual feedback session, evaluators are able to spend the majority of their time providing feedback to the evaluatees rather than inputting credentials and selecting the individual to be evaluated. This is in stark contrast to other assessment systems currently available. Existing systems require at least two to three minutes to record any assessment. With the systems and methods of the invention, the process takes less than twenty seconds to record an evaluator's feedback and less than a minute for the system to process the feedback information and generate analytics to interpret the collected data to make meaningful observations.

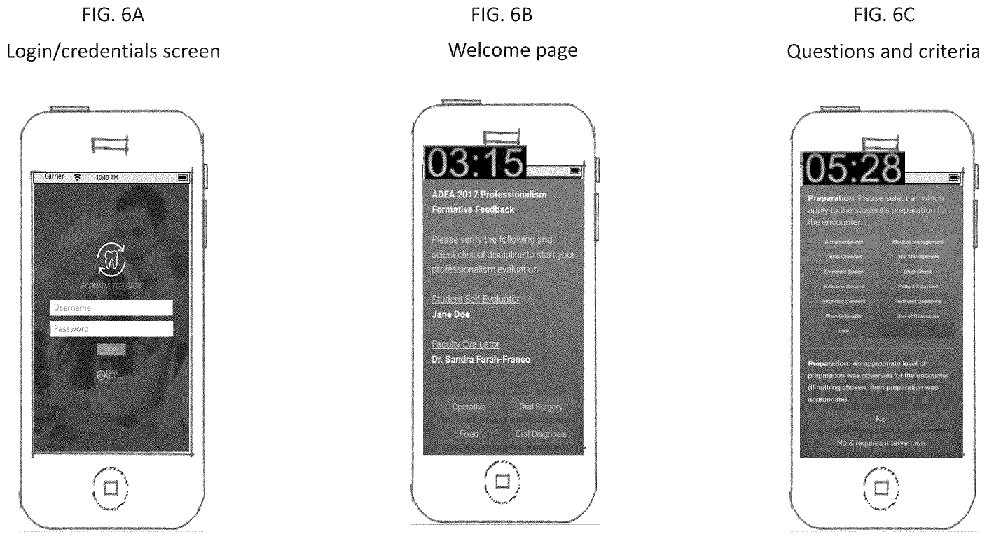

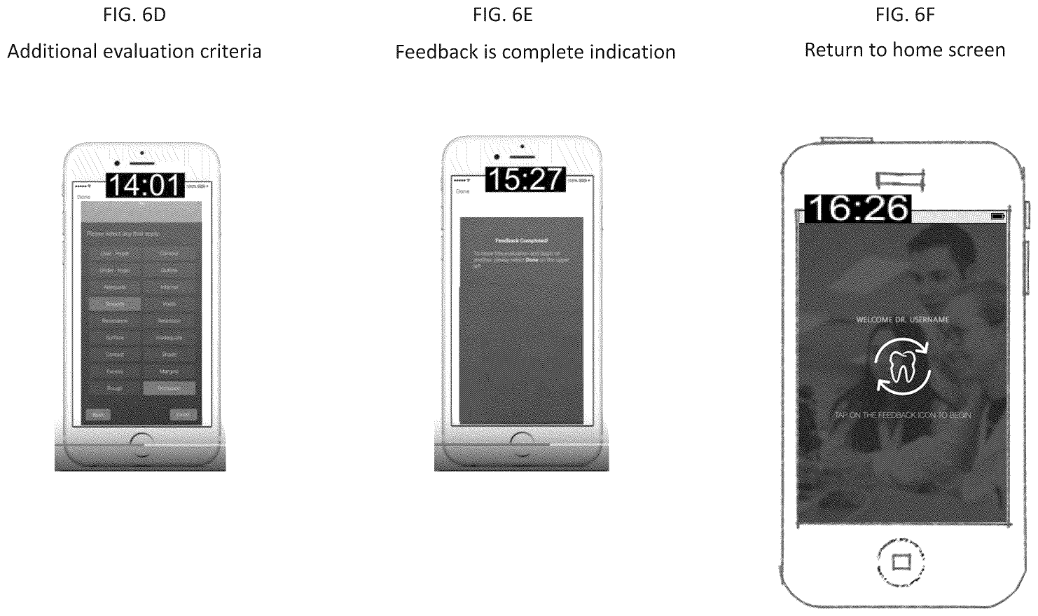

For example, an evaluator can access the formative feedback system of the invention and conduct the evaluation, feedback, and analytics review on a digital device, such as a smart phone, computer, tablet, and other computing devices. FIGS. 6A-6F show a sample workflow of one implementation of the formative feedback system of the invention utilizing QR codes and customized keywords to efficiently acquire formative feedback.

As outlined above with regard to the system components in FIG. 1, to begin the process, the system 100 presents the evaluator with a login/credentials screen, an example of which is shown in FIG. 6A. The evaluator scans a QR code that the student has which provides student, patient, and procedure information to the system 100. The student, patient, and procedure information is stored in the iFF server 120 and iFF database 125. In an exemplary embodiment, the QR codes can be static thus If an individual's ID changes, a new QR code must be issued. However, the metatags associated with each individual user are dynamic and can be changed on the fly without issuing a new QR code as the metadata resides in the single table on the iFF server.

Other information can also be included in the QR code. The evaluator views a welcome page (see FIG. 6B below) and selects “continue” to verify the student and faculty evaluator. Once verified, the evaluation begins with a set of questions, such as, “Did the technical quality of the procedure in the patient appointment or encounter meet all acceptable criteria?” See FIG. 6C. A number of criteria that may apply are also shown, and the evaluator selects those that apply. See FIG. 6C.

Additional evaluation criteria are accessed by scrolling through the list. See FIG. 6D below. Once the criteria have been selected, the device provides an indication that the feedback is complete. See FIG. 6E. The system then returns to a home screen as shown in FIG. 6F.

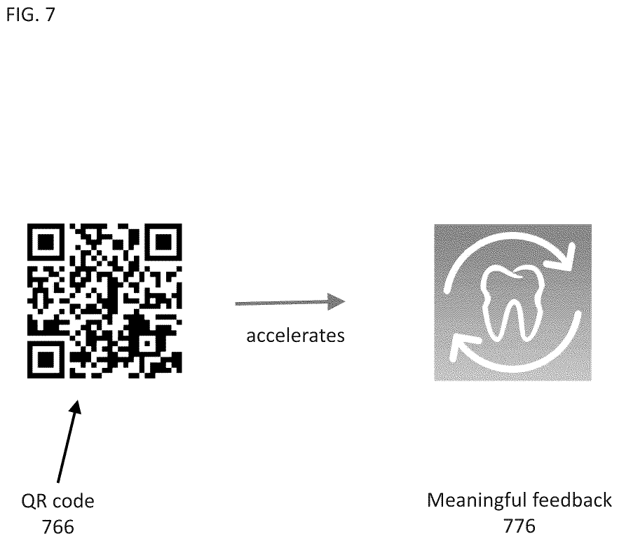

As shown pictorially in FIG. 7, the formative feedback system of the invention leverages QR Codes 766 to accelerate faculty authentication and student selection for provided feedback. Evaluators tap (e.g., a touch input provided to a touch screen) pertinent random-order descriptors to provide meaningful individualized feedback 776.

### On-Demand Dashboard Analytics

Because the data acquired is standardized, robust reporting is possible through the use of dashboard technology. Advanced, custom analytics are applied to the evaluation data, modified to each individual administrator's needs, and then displayed in real-time on mobile and desktop platforms. This enables the formative feedback system of the invention to empower users to close the assessment loop by showing them pertinent information succinctly at any time to guide the decision making process. Additionally, the data can be analyzed from multiple perspectives in an upstream and downstream manner, resulting in real-time 360-degree assessments without increasing administrative overhead or user time consumption.

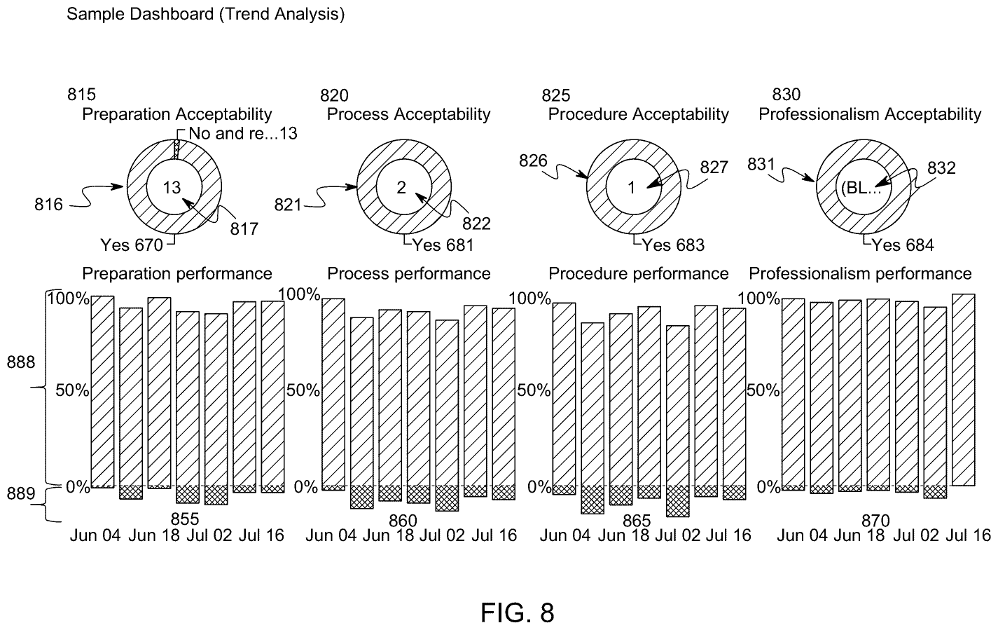

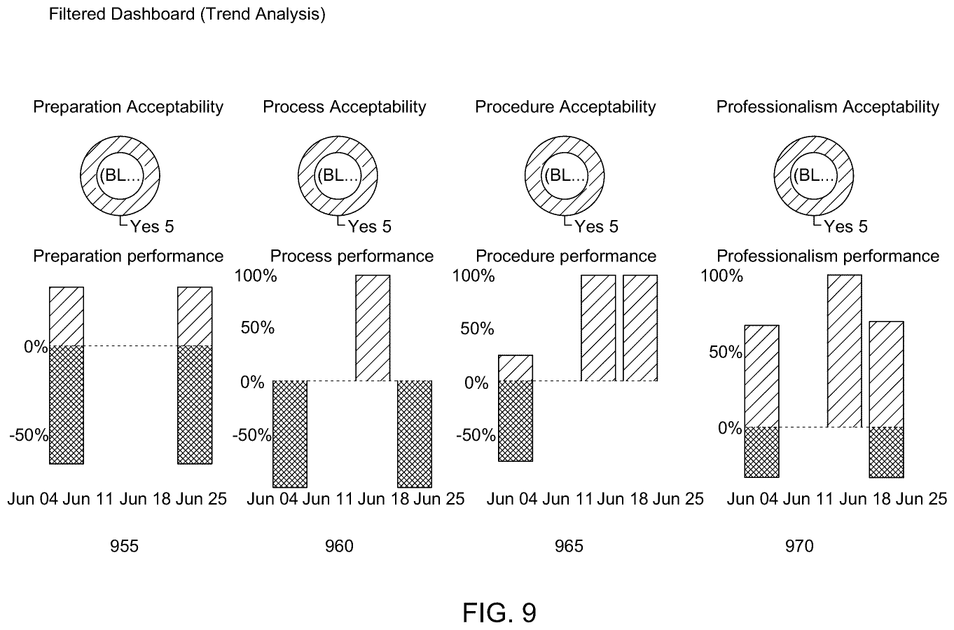

The iFF dashboard computer 140 provides a visualization of the collected evaluation data to provide a picture of the evaluatee and the evaluatee's competence in performing the skills upon which they were evaluated. The iFF dashboard computer 140 provides a customizable web-based application which applies trimming of data, concatenation of columns, calculations, row-level security definitions, and other visual analysis tools and processes to sets of evaluation data stored in the iFF Server 120 and iFF dashboard computer 140. In an exemplary embodiment, the iFF dashboard computer 140 can perform these actions based on scripts. The iFF dashboard computer 140 automatically takes the evaluation information gathered and sent by the survey application and displays it to users in an organized, meaningful, graphical format and allows users to filter results. For example, once data has been transformed by a scripted process (e.g., POWERQUERY via POWERBI), dashboards powered by the transformed data can be provided to the users. In FIG. 8, a dashboard view is optimized to show when the comments were received in order to establish evaluatee trends. FIG. 8 shows the four categories of interest (from FIG. 5) are present: Preparation 815, Process 820, Procedure 825, and Professionalism 830. The evaluation dataset includes evaluations from all the encounters of a dental school class in the time range between June 4 and July 16. In the top row, the circles 816, 821, 826, and 830 represent the number of times a category was evaluated as “Acceptable” by a faculty member (evaluator) versus how many times a category was deemed “Unacceptable” or “Unacceptable and requires intervention.” The number in the center of each circle 817, 822, 827, 832 represents how many times a procedure was found to be unacceptable and requiring intervention. For example, in the “Preparation Acceptability” graphic, there were 670 observed instances where a student's preparation skills were evaluated as acceptable. There were 13 observed instances where the student's preparation skills were evaluated as unacceptable and required intervention. Below the circular graphics 816, 821, 826, 831 are bar graphs 855, 860, 865, 870 which show the trend of performance in a given time period. Using the “Preparation Performance” bar graph 855 as an example, the green area 888 above the 0% line graphically represents all the noted strengths of a category per week. The red area 889 below the 0% line represents all the noted weaknesses of a category per week. Therefore, in the “Preparation Performance” graphic 855, this population had more observed preparation weaknesses on the week of July 2^{nd} then the week of June 4^{th}. The evaluation results can also be filtered and displayed in different dashboard views. FIG. 9 shows the same evaluation dataset depicted in FIG. 8, but FIG. 9 provides a drilled down view to an individual user (evaluatee). As evidenced by the preparation performance 955, process performance 960, procedure performance 965, and professionalism performance 970 bar graphs, this particular user (evaluatee) shows weaknesses in the first week of the semester (June 4^{th}) as well as the last week they were evaluated (June 25^{th}). Because a student is expected to progress toward competence, this dashboard in FIG. 9 highlights the student's lack of progression: time has been spent in the dental school curriculum, but the student's weaknesses have not lessened.

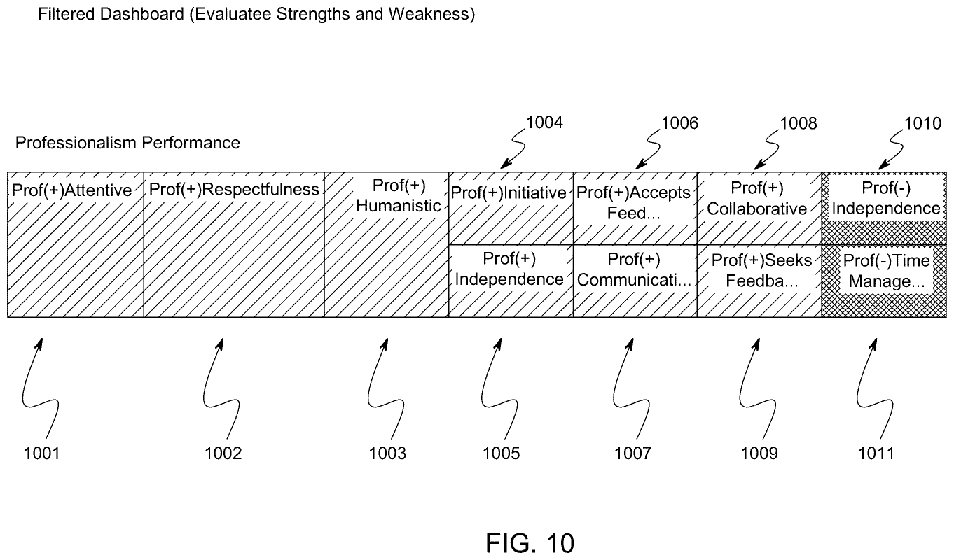

As shown in FIG. 10, the same evaluation data can also be analyzed differently. The previous graphics in FIGS. 8 and 9 show student performance over time (trend analysis) but do not indicate which area(s) the student(s) are exactly weak or strong in. The graph shown in FIG. 10 indicates the quality and quantity of comments received in order to show student (evaluatee) strengths and weaknesses in a given time period. The comments are which keywords 1001-1011 were used, with those keywords with a green background 1001-1009 being a noted strength and those keywords with a red background 1010, 1011 being a noted weakness. From the dashboard of FIG. 10, an evaluator can infer that the particular student shows a lack of professionalism due to an observed lack of independence 1010 and time management skills 1011. However, this student shows strength in attentiveness 1001, respectfulness 1002, and humanism 1003.

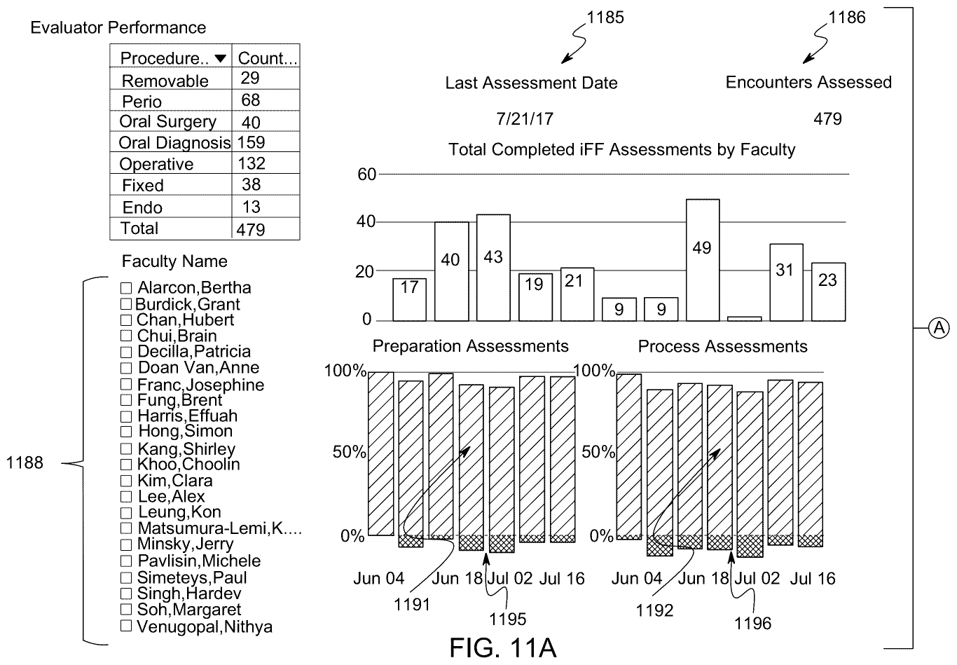

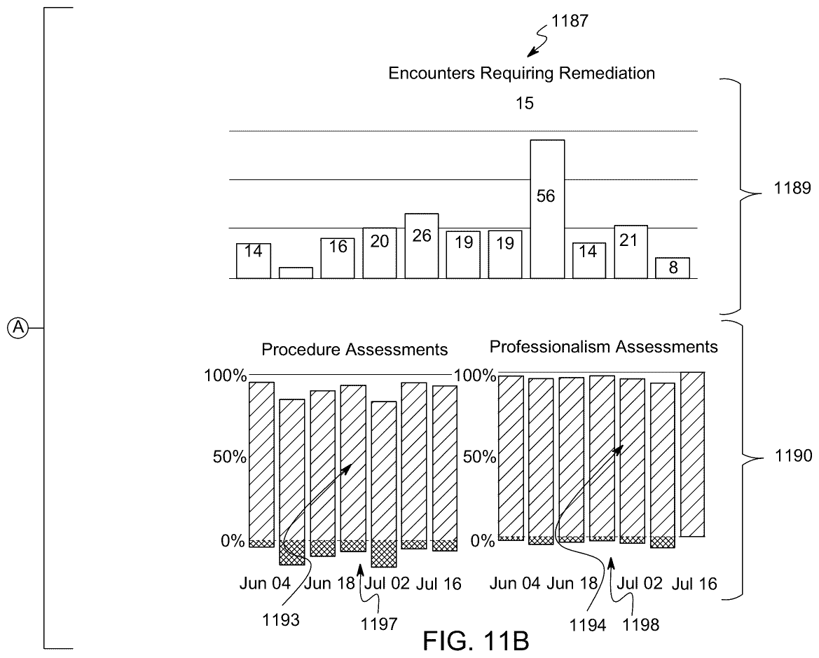

As shown in FIG. 11, the same evaluation data can also be analyzed to evaluate faculty (evaluator) performance as opposed to student (evaluatee) performance. The dashboard of FIG. 11 indicates when the last assessment was done 1185, the number of encounters assessed to date 1186, and the total number of encounters which were deemed “Unacceptable and requiring remediation” 1187. The evaluation can be filtered by participating faculty 1188. The middle bar graph 1189 shows the number of assessment which were done by the faculty evaluators. The lowest bar graph 1190 shows the level of positivity versus negativity in the faculty evaluations: the green bars 1191, 1192, 1193, 1194 in the assessment bar graphs 1190 indicates noted areas of strength and the red bars 1195, 1196, 1197, 1198 indicates noted areas of weakness. This dashboard is utilized to track faculty participation in recording assessments, the quantity of assessments they do, and the quality of the feedback given.

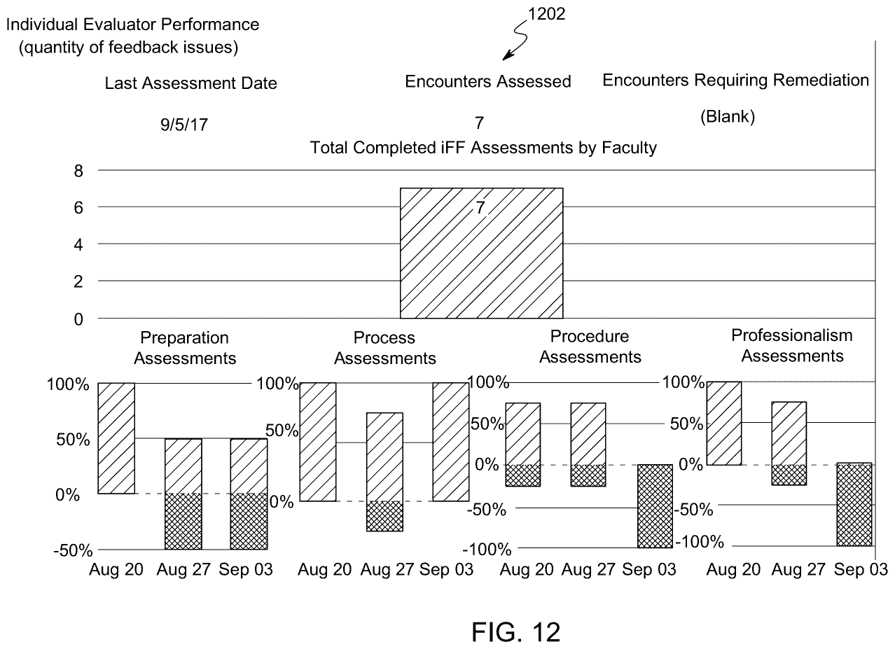

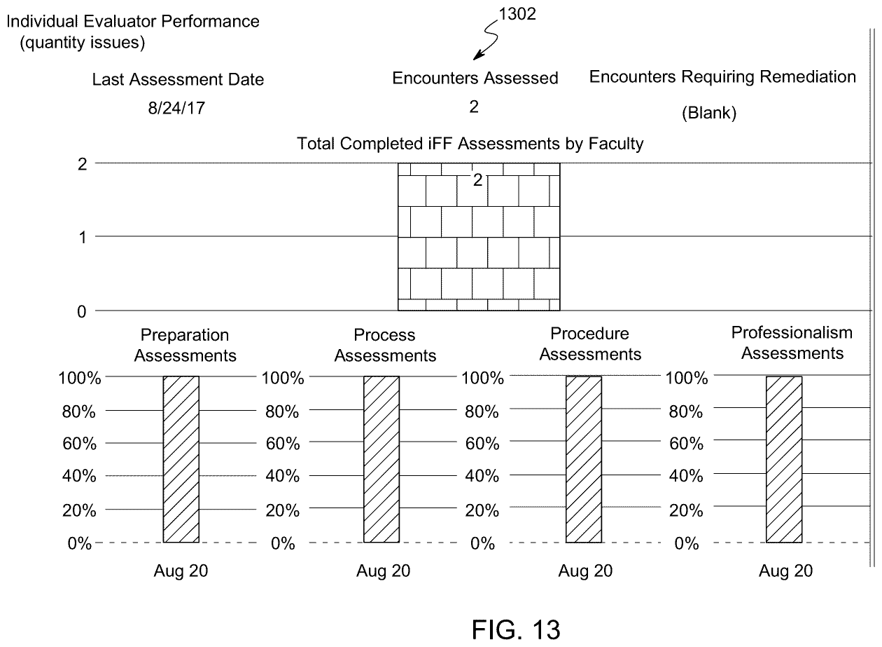

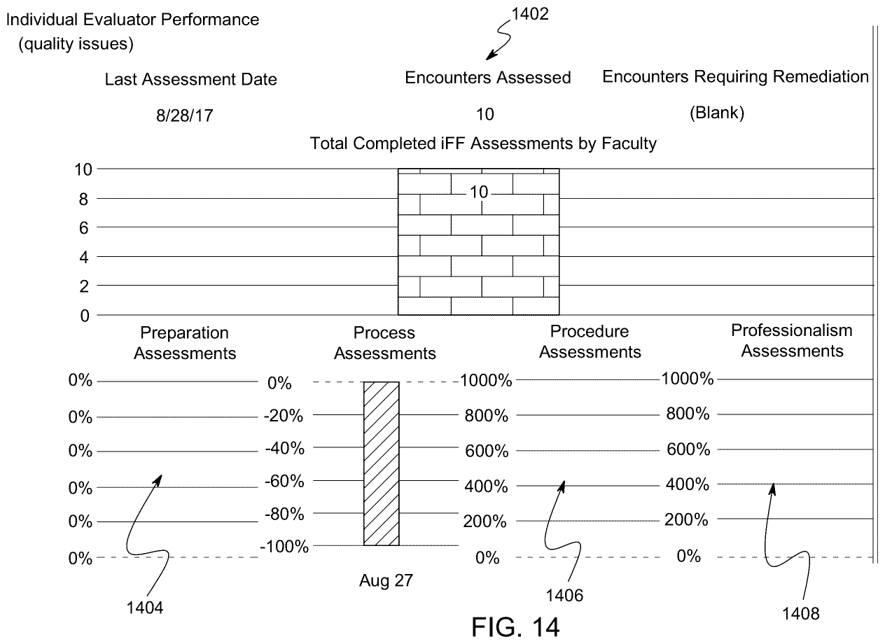

FIG. 12 provides a dashboard showing evaluator performance at the individual evaluator level. For example, FIG. 12 shows that this particular faculty member has given 7 assessments 1202 but has a focus on the weaknesses of a student. This may indicate an issue with the quantity of the faculty's feedback. Alternatively, as shown in the dashboard of FIG. 13, this faculty member (evaluator) above has almost no feedback 1302. This may indicate an issue with the quantity of the faculty's (evaluator's) feedback. FIG. 14 shows another individual evaluator dashboard illustrating that this faculty member participates in the assessment process (based on number of encounters assessed 1402) but does not provide comments as indicated in the blanks in the preparation assessment graph 1404, the procedure assessment graph 1406, and the professionalism assessment graph 1408. This indicates a possible issue with the quality of the faculty's (evaluator's) feedback.

The dashboard reports can be customized to provide evaluators and students with up-to-date information, as well as trends over time periods of their choosing. FIGS. 8-14 provide sample dashboards, including student and evaluators participating and aggregate scoring of the students' proficiencies as well as upstream assessments of the evaluator's performance based on the quality and quantity of feedback they have given students. The results can be sent or shared with individual students, groups, administrators, and the like via electronic delivery formats, including email, news feeds, social media, and other collaborative sites.

The exemplary systems and methods described herein can be performed under the control of a processing system including one or more processors executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes specific examples of accomplishing a more general goal that also may be accomplished in another way. Those skilled in the art will appreciate that the features described above can be combined in various ways to form multiple variations of the invention.

1. A formative feedback and evaluation system including a processor and memory configured to perform computer operations comprising:
receiving, with a formative feedback server from an administrator computer, a first user file including an evaluator account associated with a first evaluator, a second user file including an evaluator account associated with a second evaluator, an administrator user level, an evaluator user level associated with the first evaluator, and an evaluator user level associated with the second evaluator;
receiving, with the formative feedback server from the administrator computer, a keyword file, a category file, and a performance ratings file;
receiving, with the formative feedback server from the administrator computer, a survey framework for a formative feedback evaluation, the survey framework including formatted questions;
receiving, with the formative feedback server from a first evaluator computer, a first message including evaluatee bibliographical information, a procedure to be performed, a location of the procedure to be performed, performance evaluation criteria, and information associated with the first evaluator;
appending, with the formative feedback server, the survey framework based on the first message, wherein the survey framework is modified to include information associated with the first evaluator, administrator user level, user level of the first evaluator, evaluatee bibliographic information, procedure to be performed, location of the procedure to be performed, performance evaluation criteria, keywords, categories, and performance ratings from files associated with the evaluatee based on the information included in the first message;
delivering, from the formative feedback server to the first evaluator computer, the survey framework appended based on the first message;
receiving, with the formative feedback server from the first evaluator computer, a first survey app file corresponding to a first real-time evaluation associated with a learning encounter, wherein the first real-time evaluation information corresponding to the first evaluator observing and documenting performance of the evaluatee demonstrating the procedure to be performed during the learning encounter using the performance criteria, the keywords, the categories, and the performance ratings embedded in the survey framework appended based on the first message;
receiving, with the formative feedback server from a second evaluator computer, a second message including the evaluatee bibliographical information, the procedure to be performed, the location of the procedure to be performed, the performance evaluation criteria, and information associated with a second evaluator;
appending, with the formative feedback server, the survey framework based on the second message, wherein the survey framework is modified to include account information associated with the second evaluator, the administrator user level, user level of the second evaluator, the evaluatee bibliographic information, the procedure to be performed, the location in which the procedure is to be performed, the performance evaluation criteria, the keywords, the categories, and the performance ratings from the files associated with the evaluatee based on the information included in the second message;
delivering, from the formative feedback server to the second evaluator computer, the survey framework appended based on the second message;
receiving, with the formative feedback server from the second evaluator computer, a second survey app file corresponding to a second real-time evaluation associated with the learning encounter, wherein the second real-time evaluation is generated based on the second evaluator observing and documenting performance of the evaluatee demonstrating the procedure to be performed during the learning encounter using the performance criteria, the keywords, the categories, and the performance ratings embedded in the survey framework appended based on the second message;
saving, by the formative feedback server, the first survey app file and the second survey app file; and
receiving, with the formative feedback server from a formative feedback dashboard computer, a third message including feedback information created by collating and analyzing the first survey app file and the second survey app file.

2. The formative feedback and evaluation system of claim 1, wherein information corresponding to at least one of an administrator user account, the evaluator user account associated with the first evaluator, the evaluator user account associated with the second evaluator, the administrator user level, the evaluator user level associated with the first evaluator, or the evaluator user level associated with the second evaluator is included in an optical label.

3. The formative feedback and evaluation system of claim 2, wherein the optical label is a QR code.

4. The formative feedback and evaluation system of claim 1,
wherein at least one of the first survey app file or the second survey app file include the keyword file, and
wherein the keyword file includes neutral standardized keywords or standardized key phrases using accreditation standards and a rating indicating whether the neutral standardized keywords or the standardized key phrases connote positive or negative evaluatee performance.

5. The formative feedback and evaluation system of claim 4, wherein the keyword file includes a neutral connotation keyword data file spreadsheet generated by an evaluating organization and describing assessment aspects of a performance task.

6. The formative feedback and evaluation system of claim 4, wherein the neutral standardized keywords or the standardized key phrases are parsed and consolidated into evaluation categories and evaluation criteria by the administrator computer.

7. The formative feedback and evaluation system of claim 1, wherein the survey framework is stored in a formative feedback database as an unpopulated survey application with formatted questions and embedded account credentials for the first evaluator or the second evaluator.

8. The formative feedback and evaluation system of claim 7, wherein the unpopulated survey application is stored in the formative feedback database as a web-based survey application that runs on the first evaluator computer or the second evaluator computer inside a browser.

9. The formative feedback and evaluation system of claim 1, wherein the processor and the memory are configured to perform further computer operations comprising:
receiving, with the formative feedback server from an evaluatee computer, a third survey app file corresponding to self-evaluation criteria identified by the evaluatee,
wherein the third survey app file includes the evaluatee bibliographical information, the procedure to be performed, the location of the procedure to be performed, and the self-evaluation criteria identified by the evaluatee, and
wherein the self-evaluation criteria documents performance of the evaluatee.

10. The formative feedback and evaluation system of claim 1,
wherein the processor and the memory are configured to perform further computer operations comprising:
comparing, by a processor of the formative feedback server, at least one of the evaluatee bibliographic information, the procedure to be performed, or the location of the procedure to be performed included in the first message with information stored in a memory of the formative feedback server; and
in response to determining that the at least one of the evaluatee bibliographic information, the procedure to be performed, or the location of the procedure to be performed included in the first message matches the information stored in the memory of the formative feedback server, embedding the at least one of the evaluatee bibliographic information, the procedure to be performed, or the location of the procedure to be performed in the survey framework to create the appended survey framework,
wherein the first evaluator computer scans an optical label to identify the at least one of the evaluatee bibliographic information, the procedure to be performed, or the location of the procedure to be performed, and
wherein the administrator computer generates the optical label.

11. The formative feedback and evaluation system of claim 1, further comprising:
wherein the first evaluator computer simultaneously transmits the first survey app file to the formative feedback server and the formative feedback dashboard computer,
wherein the second evaluator computer simultaneously transmits the second survey app file to the formative feedback server and the formative feedback dashboard computer, and
wherein the formative feedback server saves the first survey app file and the second survey app file in a formative feedback database.

12. The formative feedback and evaluation system of claim 1,
wherein the processor and the memory are configured to perform further computer operations comprising:
creating, with the formative feedback server, an un-indexed URL based on the appended survey framework, wherein the un-indexed URL is used in a mobile computer survey application framework that transmits and receives embedded text fields within the un-indexed URL to ensure integrity of evaluations while allowing cross-platform access and data communication from servers, and
wherein the un-indexed URL prevents the evaluatee bibliographical information from being identified outside of the formative feedback server.

13. A computer implemented method, executed on a formative feedback server including a processor and memory configured to perform operations of creating formative feedback and evaluations comprising:
receiving, a via a communication interface of the formative feedback server, a user file transmitted from an administrator computer, the user file including an evaluator account associated with a first evaluator, an evaluator account associated with a second evaluator, an administrator user level, an evaluator user level associated with the first evaluator, and an evaluator user level associated with the second evaluator;
receiving, via the communication interface of the formative feedback server, a keyword file, a category file, and a performance ratings file from the administrator computer;
receiving, via the communication interface of the formative feedback server, a survey framework for a formative feedback evaluation from the administrator computer, the survey framework including formatted questions;
receiving, via the communication interface of the formative feedback server, a first message from a first evaluator computer, the first message including evaluatee bibliographical information, a procedure to be performed, a location of the procedure to be performed, performance evaluation criteria, and information associated with the first evaluator;
appending, by a processor of the formative feedback server, the survey framework based on the first message, wherein the survey framework is modified to include information associated with the first evaluator, evaluatee bibliographic information, keywords, categories, and performance ratings from based on the user file, the keyword file, the category file, and performance ratings file received from the administrator computer;
transmitting, via the communication interface of the formative feedback server, the survey framework appended based on the first message received from the first evaluator computer;
receiving, via the communication interface of the formative feedback server, a first survey app file corresponding to a first real-time evaluation associated with a learning encounter, wherein the first real-time evaluation information corresponds to the first evaluator observing and documenting performance of the evaluatee demonstrating the procedure to be performed during the learning encounter using the performance criteria, the keywords, the categories, and the performance ratings embedded in the survey framework appended based on the first message;
receiving, via the communication interface of the formative feedback server, a second message from a second evaluator computer, the second message including the evaluatee bibliographical information, the procedure to be performed, the location of the procedure to be performed, the performance evaluation criteria, and information associated with the second evaluator;
appending, by the processor of the formative feedback server, the survey framework based on the second message, wherein the survey framework is modified to include information associated with the second evaluator, the evaluatee bibliographic information, the keywords, the categories, and the performance ratings based on the user file, the keyword file, the category file, and the performance ratings file received from the administrator computer;
transmitting, via the communication interface of the formative feedback server, the survey framework appended based on the second message to the second evaluator computer;
receiving, via the communication interface of the formative feedback server, a second survey app file corresponding to a second real-time evaluation associated with the learning encounter, wherein the second real-time evaluation information corresponds to the second evaluator observing and documenting performance of the evaluatee demonstrating the procedure to be performed during the learning encounter using the performance criteria, the keywords, the categories, and the performance ratings embedded in the survey framework appended based on the second message;
saving, in a memory of the formative feedback server, the first survey app file and the second survey app file; and
receiving, via the communication interface of the formative feedback server, a third message including feedback information created by collating and analyzing the first survey app file and the second survey app file from a formative feedback dashboard computer.

14. The computer implemented method of creating formative feedback and evaluations of claim 13,
wherein at least one of the first survey app file or the second survey app file include the keyword file, and
wherein the keyword file includes neutral standardized keywords or standardized key phrases using accreditation standards and a rating indicating whether the neutral standardized keywords or standardized key phrases connote positive or negative evaluatee performance.

15. The computer implemented method of creating formative feedback and evaluations of claim 14, wherein the standardized keywords or the standardized key phrases are parsed and consolidated into evaluation categories and evaluation criteria by the administrator computer.

16. The computer implemented method of creating formative feedback and evaluations of claim 13, further comprising:
storing the survey framework in a formative feedback database,
wherein the survey framework is stored as an unpopulated web-based survey application that runs on the first evaluator computer or the second evaluator computer inside a browser and includes formatted questions and embedded account credentials for the first evaluator or the second evaluator, respectively.

17. The computer implemented method of creating formative feedback and evaluations of claim 13 further comprising:
receiving, via the communication interface of the feedback server, a third survey app file corresponding to self-evaluation criteria identified by the evaluatee,
wherein the third survey app file includes the evaluatee bibliographical information, the procedure to be performed, the location of the procedure to be performed, and the self-evaluation criteria identified by the evaluatee, and
wherein the self-evaluation criteria documents performance of the evaluatee.

18. The computer implemented method of creating formative feedback and evaluations of claim 13, further comprising:
comparing, by the processor of the formative feedback server, at least one of the evaluatee bibliographic information, the procedure to be performed, or the location of the procedure to be performed included in the first message with information stored in a memory of the formative feedback server; and
in response to determining that the at least one of the evaluatee bibliographic information, the procedure to be performed, or the location of the procedure to be performed included in the first message matches the information stored in the memory of the formative feedback server, embedding the at least one of the evaluatee bibliographic information, the procedure to be performed, or the location of the procedure to be performed in the survey frame work to create the appended survey framework,
wherein the first evaluator computer scans an optical label to identify the at least one of the evaluatee bibliographic information, the procedure to be performed, or the location of the procedure to be performed, and
wherein the administrator computer generates the optical label.

19. The computer implemented method of creating formative feedback and evaluations of claim 13,
wherein the first evaluator computer simultaneously transmits the first survey app file to the formative feedback server and the formative feedback dashboard computer,
wherein the second evaluator computer simultaneously transmits the second survey app file to the formative feedback server and the formative feedback dashboard computer, and
wherein the formative feedback server saves the first survey app file and the second survey app file in a formative feedback database.

20. The computer implemented method of creating formative feedback and evaluations of claim 13, wherein the survey framework is a mobile computer application framework, and the method further comprises:
creating, by the processor of the formative feedback server, an un-indexed URL based on the appended survey framework, wherein the un-indexed URL is used in a mobile computer survey application framework that transmits and receives embedded text fields within the un-indexed URL to ensure integrity of evaluations while allowing cross-platform access to the mobile computer application framework and data communication from servers,
wherein the un-indexed URL prevents the evaluatee bibliographical information from being identified outside of the formative feedback server.
